(19) United States
(12) Patent Application Publication
(10) Pub. No.: US 2020/0293067 A1
(43) Pub. Date: Sep. 17, 2020

(54) STATE ESTIMATION

(71) Applicant: SZ DJI TECHNOLOGY CO., LTD., Shenzhen (CN)

(72) Inventors: Guozheng LU, Shenzhen (CN); Fu ZHANG, Shenzhen (CN)

(21) Appl. No.: 16/891,623

(22) Filed: Jun. 3, 2020

Related U.S. Application Data
(63) Continuation of application No. PCT/CN2017/118971, filed on Dec. 27, 2017.

(51) Int. Cl. G05D 1/08; G01C 21/16; G01C 21/18; G01C 21/20

(52) U.S. Cl. CPC G05D 1/0816; G01C 21/20; G01C 21/18; G01C 21/165

(57) ABSTRACT

A method for estimating a state associated with a mobile body includes obtaining measurements from a plurality of measuring devices associated with the mobile body. The plurality of measuring devices include an accelerometer and the measurement from the accelerometer is filtered using a noise filter. The method further includes predicting, based at least in part on a first estimate of the state associated with the mobile body and a plurality of models, a second estimate of the state. The plurality of models include a filter model for the noise filter. The method also includes updating the second estimate of the state based at least in part on the measurements from the plurality of measuring devices to obtain a third estimate of the state.

### CROSS-REFERENCE TO RELATED APPLICATION

This application is a continuation of International Application No. PCT/CN2017/118971, filed Dec. 27, 2017, the entire content of which is incorporated herein by reference.

### TECHNICAL FIELD

The present disclosure relates to attitude control techniques and, more particularly, to a method and device for estimating a state associated with a mobile body, including an attitude of the mobile body in the presence of narrowband noise.

### BACKGROUND

Attitude control has been widely used as a major means or an important supplement in controlling various systems, such as unmanned aerial vehicles (UAVs) and multi-axis gimbal systems, e.g., to stabilize the systems. To realize attitude control, the attitude of the system being controlled needs to be estimated. Attitude estimation includes determining the orientation of one or more rigid bodies of the system based on outputs from one or more sensors, which are usually non-ideal and noisy.

The attitude of a rigid body is usually measured according to one of two methods. One method includes using a line-of-sight attitude sensor, such as an accelerometer and a magnetometer, to obtain the attitude. The other method includes integrating the angular velocity of the body measured by a rate gyroscope. Accelerometers are stable in long-term measurement but sensitive to vibrations and translational acceleration. On the other hand, gyroscopes randomly drift over time, which, once integrated, results in accumulated errors.

Further, attitude estimation using a line-of-sight attitude sensor usually includes known models and reference. Noises caused by vibrations usually include non-Gaussian white noises, which are difficult to be accurately modeled, which impacts the accuracy of the estimation results.

### SUMMARY

In accordance with the present disclosure, there is provided a method for estimating a state associated with a mobile body. The method includes obtaining measurements from a plurality of measuring devices associated with the mobile body. The plurality of measuring devices include an accelerometer and the measurement from the accelerometer is filtered using a noise filter. The method further includes predicting, based at least in part on a first estimate of the state associated with the mobile body and a plurality of models, a second estimate of the state. The plurality of models include a filter model for the noise filter. The method also includes updating the second estimate of the state based at least in part on the measurements from the plurality of measuring devices to obtain a third estimate of the state.

Also in accordance with the present disclosure, there is provided a device for estimating a state associated with a mobile body. The device includes a processor and a memory storing instructions that, when executed by the processor, cause the processor to obtain measurements from a plurality of measuring devices associated with the mobile body. The plurality of measuring devices include an accelerometer and the measurement from the accelerometer is filtered using a noise filter. The instructions further cause the processor to predict, based at least in part on a first estimate of the state associated with the mobile body and a plurality of models, a second estimate of the state. The plurality of models include a filter model for the noise filter. The instructions also cause the processor to update the second estimate of the state based at least in part on the measurements from the plurality of measuring devices to obtain a third estimate of the state.

Also in accordance with the present disclosure, there is provided a controlling device for controlling a mobile body. The controlling device includes a processor and a memory storing instructions that, when executed by the processor, cause the processor to obtain measurements from a plurality of measuring devices associated with the mobile body. The plurality of measuring devices include an accelerometer and the measurement from the accelerometer is filtered using a noise filter. The instructions further cause the processor to predict, based at least in part on a first estimate of the state associated with the mobile body and a plurality of models, a second estimate of the state. The plurality of models include a filter model for the noise filter. The instructions also cause the processor to update the second estimate of the state based at least in part on the measurements from the plurality of measuring devices to obtain a third estimate of the state, and control the mobile body according to the third estimate of the state.

Also in accordance with the present disclosure, there is provided a mobile system including an unmanned aerial vehicle (UAV), a gimbal carried by the UAV, a plurality of measuring devices associated with the gimbal, and a controlling device. The plurality of measuring devices including an accelerometer. The controlling device includes a processor and a memory storing instructions that, when executed by the processor, cause the processor to obtain measurements from the plurality of measuring devices. The measurement from the accelerometer is filtered using a noise filter. The instructions further cause the processor to predict, based at least in part on a first estimate of the state associated with the mobile body and a plurality of models, a second estimate of the state. The plurality of models including a filter model for the noise filter. The instructions also cause the processor to update the second estimate of the state based at least in part on the measurements from the plurality of measuring devices to obtain a third estimate of the state.

### BRIEF DESCRIPTION OF THE DRAWINGS

FIGS. 1A and 1B schematically show a mobile system according to some embodiments of the disclosure.

FIG. 2 schematically shows a relationship between the geodetic coordinate system X′Y′Z′O and the body coordinate system XYZO of a gimbal shown in FIG. 1.

FIG. 3A is a block diagram schematically showing an estimating system according to some embodiments of the disclosure.

FIG. 3B is a schematic block diagram of a frequency estimation system in FIG. 3 according to some embodiments of the disclosure.

FIG. 4 shows a Bode plot of an example notch filter according to some embodiments of the disclosure.

FIG. 5 is a schematic block diagram of an example of the estimating system according to some embodiments of the disclosure.

FIG. 6 is a flow chart schematically showing a method for estimating a state associated with a mobile body according to some embodiments of the disclosure.

FIG. 7 is a flow chart schematically showing a method for estimating the state associated with the mobile body according to some other embodiments of the disclosure.

FIGS. 8A and 8B show results of an experiment performed on a gimbal.

FIG. 9 shows an example frequency spectrum of accelerometer noise.

FIG. 10 is a flow chart schematically showing a method for controlling an attitude of a mobile body according to some embodiments of the disclosure.

### DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings and the specification to refer to the same or like parts.

Consistent with embodiments of the disclosure, various measuring devices associated with a mobile body can provide a plurality of measurement results, also referred to as “measurements,” which can be subjected to an estimating system to obtain an estimated state associated with the mobile body, such as an estimated attitude of the mobile body or an estimated bias in a measurement by a measuring device associated with the mobile body. The estimating system consistent with the disclosure may include a plant system and an observer system. The plant system describes actual physical relationships among various physical quantities, including physical quantities measured by the measuring devices.

The plant system consistent with the disclosure may include a noise filter for filtering out noises caused by vibrations of the mobile body, which are also referred to as “vibration noises” and usually include non-Gaussian white noises. The noises caused by the vibrations of the mobile body can usually be included in the measurement results from an accelerometer associated with the mobile body, as described in more detail below.

The observer system may use a plurality of models for estimating the state associated with the mobile body. The plurality of models can include, for example, at least one of an attitude kinematic model configured to model a relationship between an attitude of the mobile body and an angular velocity of the mobile body, a filter model configured to model the noise filter, or measuring device models each configured to model one of the measuring devices. In some embodiments, the noise filter can be included in the observer system and the filter model and/or the measuring device models can be integrated into a state model configured to model one or more states associated with the mobile body. Such an observer system including the noise filter can also be referred to as an augmented system.

The mobile body can be, for example, an unmanned aerial vehicle (UAV), a gimbal carried by a UAV, or a hand-held gimbal. In the examples of UAV or gimbal carried by a UAV being the mobile body, the vibration noises can include, for example, narrowband noises caused by propeller vibration, structural modes, or aerodynamic turbulence.

In this disclosure, unless otherwise specified, a bolded symbol represents a quantity, e.g., a parameter, a coefficient, or a variable, that is a vector or a matrix. Subscript “m” in a symbol indicates that the corresponding quantity is a measured quantity, which can either have a value actually measured using a measuring device or a value obtained through mathematical calculation based on one or more actually measured quantities. A symbol with “\hat{ }” on the top represents an estimated value of the corresponding quantity.

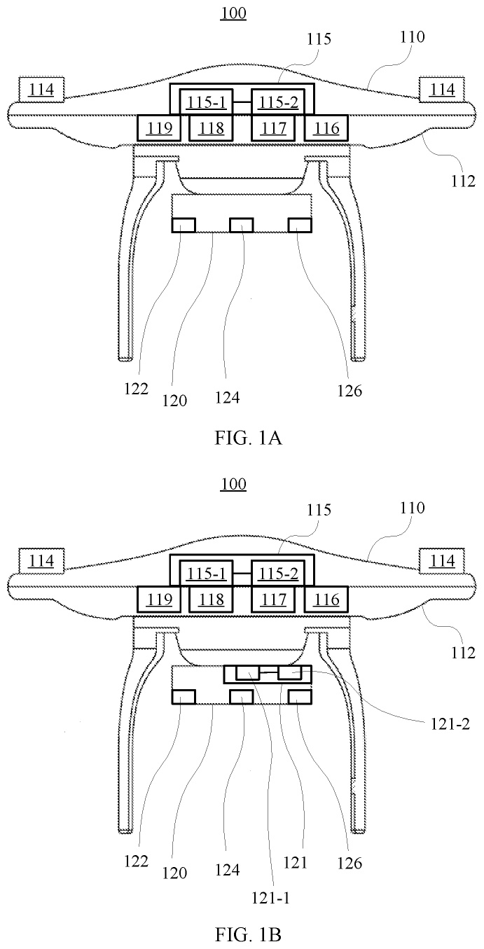

FIGS. 1A and 1B schematically show a mobile system 100 according to some embodiments of the disclosure. The mobile system 100 includes a UAV 110 and a gimbal 120 coupled to, e.g., carried by, the UAV 110. The UAV 110 or the gimbal 120 can be the example of the mobile body consistent with embodiments of the disclosure.

As shown in FIG. 1A, the UAV 110 includes a housing 112 for accommodating or carrying various components of the UAV 110. The UAV 110 further includes a propulsion system 114 mounted on the housing 112 for driving the UAV 110 to move around. The propulsion system 114 may include one or more rotors, which can rotate to generate lift for the UAV 110, enabling the UAV 110 to move about freely in the air at any attitude.

The UAV 110 further includes a controlling device 115 for controlling the operation of the UAV 110 and/or the gimbal 120. For example, the controlling device 115 can generate control signals to instruct the propulsion system 114 to generate a proper force to move the UAV 110 around, or generate control signals to control the operation of other components of the mobile system 100, such as the gimbal 120.

In some embodiments, the controlling device 115 can estimate the state associated with the UAV 110 and/or the state associated with the gimbal 120, such as the attitude of the UAV 110 and/or the attitude of the gimbal 120, based on measurement results obtained by various measuring devices carried by the system 100. According to the state estimation result, the controlling device 115 can generate control signals for controlling the UAV 110 or the gimbal 120, such as control signals instructing the propulsion system 114 to generate a proper force to maintain or change the attitude of the UAV 110, or control signals instructing various motors associated with the gimbal 120 to operate accordingly to maintain or change the attitude of the gimbal 120.

The controlling device 115 includes a memory 115-1 and a processor 115-2 coupled to each other. The memory 115-1 stores instructions, e.g., in the form of computer program codes, that, when executed by the processor 115-2, cause the processor 115-2 to perform a method consistent with the disclosure, such as one of the state estimation methods or the control methods described below. The processor 115-2 is configured to execute the instructions stored in the memory 115-1 to perform a method consistent with the disclosure.

The memory 115-1 can include a non-transitory computer-readable storage medium, such as a random access memory (RAM), a read only memory, a flash memory, a hard disk storage, or an optical media. The processor 115-2 can include any suitable hardware processor, such as a microprocessor, a micro-controller, a central processing unit (CPU), a graphic processing unit (GPU), a network processor (NP), a digital signal processor (DSP), an application specific integrated circuit (ASIC), a field-programmable gate array (FPGA), or another programmable logic device, discrete gate or transistor logic device, discrete hardware component.

In some embodiments, the controlling device 115 can include a dedicated state-estimating device configured to estimate the state associated with the UAV 110 and/or the state associated with the gimbal 120. The state-estimating device can separately include a memory and a processor coupled to each other. The memory can store instructions, e.g., in the form of computer program codes, that, when executed by the processor, cause the processor to perform a method consistent with the disclosure, such as one of the state estimation methods described below. The processor can be configured to execute the instructions stored in the memory to perform a method consistent with the disclosure. The memory and the processor of the state-estimating device can be similar to the memory 115-1 and the processor 115-2 of the controlling device 115 as described above.

In some embodiments, additionally or alternatively, the gimbal 120 includes a controlling device 121, as shown in FIG. 1B. The controlling device 121 can be configured to control the operation of the gimbal 120. For example, the controlling device 121 can estimate the state associated with the gimbal 120, such as the attitude of the gimbal 120, based on measurement results obtained by various measuring devices carried by the mobile system 100. According to the state estimation result, the controlling device 121 can generate control signals for controlling the gimbal 120, such as control signals instructing various motors associated with the gimbal 120 to operate accordingly to maintain or change the attitude of the gimbal 120.

Similar to the controlling device 115, the controlling device 121 also includes a memory 121-1 and a processor 121-2 coupled to each other. The memory 121-1 stores instructions, e.g., in the form of computer program codes, that, when executed by the processor 121-2, cause the processor 121-2 to perform a method consistent with the disclosure, such as one of the state estimation methods or the control methods described below. The processor 121-2 is configured to execute the instructions stored in the memory 121-1 to perform a method consistent with the disclosure.

Similar to the memory 115-1, the memory 121-1 can include a non-transitory computer-readable storage medium, such as a random access memory (RAM), a read only memory, a flash memory, a hard disk storage, or an optical media. Similar to the processor 115-2, the processor 121-2 can include any suitable hardware processor, such as a microprocessor, a micro-controller, a central processing unit (CPU), a graphic processing unit (GPU), a network processor (NP), a digital signal processor (DSP), an application specific integrated circuit (ASIC), a field-programmable gate array (FPGA), or another programmable logic device, discrete gate or transistor logic device, discrete hardware component.

The system 100 can carry various measuring devices, such as sensors, for measuring various physical quantities that can be used, for example, in controlling the operation of the system 100, such as the UAV 110 and/or the gimbal 120. The various measuring devices can be carried on the UAV 110 and/or the gimbal 120, as described in more detail below.

As shown in FIGS. 1A and 1B, the UAV 110 includes a translational acceleration measurement device 116 configured to measure a translational acceleration of the UAV 110 in one or more directions. As used herein, the translational acceleration of the UAV 110 refers to an acceleration associated with the movement of the UAV 110, which can reflect how fast the UAV 110 changes its translational velocity. The translational acceleration measurement device 116 can include, for example, a satellite navigation device, such as a Global Positioning System (GPS) receiver, a Global Navigation Satellite System (GLONASS) receiver, a Galileo navigation system receiver, or a BeiDou Navigation Satellite System (BeiDou) receiver. For example, by detecting the change of location of the UAV 110 over time, the translational acceleration measurement device 116 can measure the translational acceleration of the UAV 110.

In some embodiments, as shown in FIGS. 1A and 1B, the UAV 110 further includes one or more of a gyroscope 117 configured to measure an angular velocity of the UAV 110, an accelerometer 118 configured to measure an acceleration of the UAV 110 (also referred to as a linear acceleration of the UAV 110), and an electronic compass 119 configured to measure an Euler angle, such as a yaw angle, of the UAV 110. The electronic compass 119 can be, e.g., a three-axis magnetometer. The one or more of the gyroscope 117, the accelerometer 118, and the electronic compass 119 can form an inertial measurement unit (IMU) of the UAV 110. For example, the IMU of the UAV 110 can include the gyroscope 117 and the accelerometer 118. As another example, the IMU of the UAV 110 can include the gyroscope 117, the accelerometer 118, and the electronic compass 119. The acceleration of the UAV 110 can be a combined result of a translational acceleration of the UAV 110 and a gravitational acceleration, which can be expressed in a coordinate system associated with the UAV 110. The translational acceleration of the UAV 110 can be measured, e.g., by the translational acceleration measurement device 116 as described above.

The gimbal 120 is connected to the UAV 110 via, for example, a joint motor (not shown). The gimbal 120 can be used to carry a payload of the system 100, such as a photographing device or a delivering device. As shown in FIGS. 1A and 1B, a gyroscope 122 and an accelerometer 124 are arranged on the gimbal 120. The gyroscope 122 and the accelerometer 124 can constitute an IMU of the gimbal 120. The gyroscope 122 is configured to measure an angular velocity of the gimbal 120. The accelerometer 124 is configured to measure an acceleration of the gimbal 120, which can also be referred to as a linear acceleration of the gimbal 120. The acceleration of the gimbal 120 can be a combined result of a translational acceleration of the gimbal 120 and a gravitational acceleration. The translational acceleration of the gimbal 120 can be the same as the translational acceleration of the UAV 110, and thus can be obtained from the translational acceleration measurement device 116 described above. Usually, the translational acceleration of the UAV 110 is measured in the coordinate system associated with the UAV 110. In some embodiments, the coordinate system associated with the UAV 110 may be different from the coordinate system associated with the gimbal 120. For example, the coordinate system associated with the gimbal 120 may rotate with respect to the coordinate system associated with the UAV 110 for a certain degree. In these embodiments, the translational acceleration of the UAV 110 measured by the translational acceleration measurement device 116, which is expressed in the coordinate system associated with the UAV 110 can be converted into a translational acceleration of the gimbal 120 expressed in the coordinate system of the gimbal 120. In some embodiments, the translational acceleration measurement device 116 can be arranged on the gimbal 120 and can directly measure the translational acceleration of the gimbal 120.

As described above, the electronic compass 119 is configured to measure the Euler angle, such as the yaw angle, of the UAV 110. In some embodiments, the connection between the gimbal 120 and the UAV 110 may be rigid, i.e., the gimbal 120 does not rotate with respect to the UAV 110, or semi-rigid, i.e., the gimbal 120 may rotate with respect to the UAV 110 around one or more axes but cannot rotate around one or more other axes. In these embodiments, one or more Euler angles, e.g., the yaw angle, of the UAV 110 can be directly regarded/used as one or more Euler angles, e.g., the yaw angle, of the gimbal 120. In some other embodiments, the gimbal 120 can rotate freely with respect to the UAV 110, i.e., around all axes, all Euler angles, e.g., the yaw angle, of the gimbal 120 can be different from those of the UAV 110. In these embodiments, the Euler angle, e.g., the yaw angle, of the gimbal 120 can be obtained according to the Euler angle, e.g., the yaw angle, of the UAV 110 and a rotation angle of the gimbal 120 with respect to the UAV 110, such as a rotation angle of the gimbal 120 with respect to the UAV 110 in the yaw direction. The rotation angle of the gimbal 120 with respect to the UAV 110 in the yaw direction can be, for example, a rotation angle of the joint motor connecting the gimbal 120 with the UAV 110.

In some embodiments, as shown in FIGS. 1A and 1B, the gimbal 120 also includes an electronic compass 126 configured to measure the Euler angle, e.g., the yaw angle, of the gimbal 120. Similar to the electronic compass 119, the electronic compass 126 can be, e.g., a three-axis magnetometer. The electronic compass 126 can also be a part of the IMU of the gimbal 120.

As described above, consistent with embodiments of the disclosure, the state associated with a mobile body, such as the UAV 110, the gimbal 120 carried by the UAV 110, or a handheld gimbal, can be estimated using an estimating system based at least in part on a plurality of models including an attitude kinematic model, a filter model configured to model a noise filter, and/or measuring device models each configured to model one of the measuring devices, such as one or more of the above-described measuring devices. In some embodiments, the filter model and/or the measuring device models can be integrated as a part of a state model describing the state or a change of the state associated with the mobile body. Consistent with the disclosure, the state associated with the mobile body can include, for example, the attitude of the mobile body.

Hereinafter, example embodiments will be described with the gimbal 120 as an example of the mobile body. It is noted, however, the descriptions are also completely or partially applicable to other embodiments with a different mobile body, such as the UAV 110.

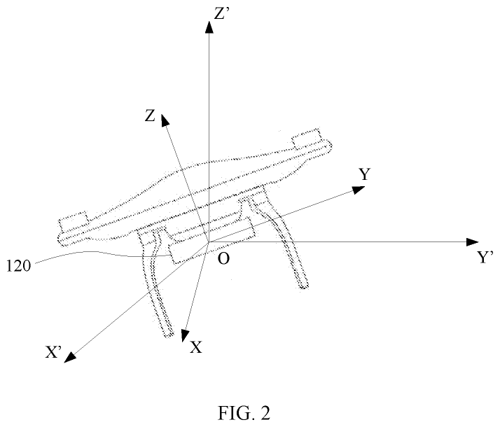

The attitude of a mobile body may refer to a rotation R from a geodetic coordinate system to a body coordinate system of the mobile body. As an example, FIG. 2 schematically shows a relationship between the geodetic coordinate system X′Y′Z′O and the body coordinate system XYZO of the gimbal 120. Since the rotation occurs in a three-dimensional (3D) space, the rotation R from the geodetic coordinate system to the body coordinate system of the mobile body, such as the gimbal 120, can be expressed as a 3×3 rotation matrix (denoted as R∈ [symbol] ^{3×3}) that has a determinant equaling 1. In this disclosure, an estimated attitude of the mobile body, such as the gimbal 120, is denoted as \hat{R}. The rotation R can be interpreted as a rotation about an axis ξ of angle θ. The axis ξ and the angle θ are related to the rotation matrix by an exponential map:

$$\begin{matrix}R = {e}^{{θ}_{x}} & ( 1 a ) \\ {θ}_{x} {=}^{Δ} [ \begin{matrix}0 & - {θ}_{3} & {θ}_{2} \\ {θ}_{3} & 0 & - {θ}_{1} \\ - {θ}_{2} & {θ}_{1} & 0\end{matrix} ] & ( 1 b )\end{matrix}$$

where θ=θξ and the norm of ξ equals 1. Further,

$$exp ( A ) = {\sum }_{n = 0}^{∞} \frac{{A}^{n}}{n !}$$

is matrix exponential.

The estimating system consistent with the disclosure uses measurement results from various measuring devices associated with the mobile body as inputs, and outputs an estimated attitude of the mobile body. Since the measurement results from the measuring devices usually contain various noises, which may be either Gaussian white noises or non-Gaussian white noises, the estimating system consistent with the disclosure can reduce the impact of the noises on the attitude estimation and provide an estimated attitude that is close to an actual attitude of the mobile body.

In the example that the mobile body includes the gimbal 120 as described herein, the inputs to the estimating system can include, for example, a measured angular velocity, ωₘ, a measured acceleration (also referred to as a measured linear acceleration), aₘ, a measured yaw angle, ψₘ, (as an example of a measured Euler angle), and a measured translational acceleration, a_{cm}, of the gimbal 120. In some embodiments, the measured angular velocity ωₘ can be obtained by the gyroscope 122, the measured acceleration aₘ can be obtained by the accelerometer 124, the measured yaw angle θₘ can be obtained directly by the electronic compass 126 or indirectly from the electronic compass 119, and the measured translational acceleration, a_{cm} can be obtained by the translational acceleration measurement device 116. Correspondingly, the outputs from the estimating system can include states associated with the mobile body, such as the estimated attitude, \hat{R}, of the mobile body.

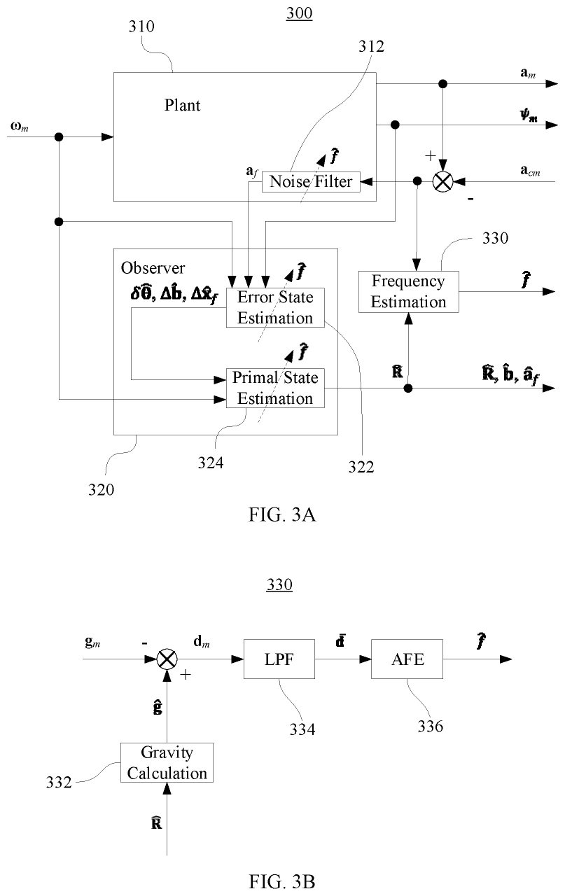

FIG. 3A is a block diagram schematically showing an estimating system 300 according to some embodiments of the disclosure for estimating the attitude of a mobile body. As shown in FIG. 3A, the estimating system 300 includes a plant system 310, an observer system 320, and a frequency estimation system 330 coupled to each other. As shown in FIG. 3A, the estimating system 300 uses the measured angular velocity ωₘ, the measured acceleration aₘ, the measured yaw angle ψₘ, and the measured translational acceleration a_{cm} as inputs to produce outputs including the estimated attitude \hat{R} of the mobile body.

The plant system 310 describes actual relationships among various physical quantities associated with the attitude of the mobile body, such as the angular velocity, the acceleration, and the yaw angle of the mobile body. In some embodiments, the plant system 310 can be regarded as including a series processes that, when the angular velocity is subject to the processes, would have obtained calculation results including the acceleration and the yaw angle. Therefore, although the measured acceleration aₘ and the measured yaw angle ψₘ are the inputs of the entire estimating system 300, they are depicted as “outputs” of the plant system 310 in FIG. 3A.

To reduce or eliminate the impact of the vibration noises on the state estimation, the plant system 310 includes a noise filter 312. The measured translational acceleration a_{cm} is subtracted from the measured acceleration aₘ, and the difference is then input into the noise filter 312 for filtering out measurement noises, such as the vibration noises. The noise filter 312 can include one or more noise filtering units, each of which can be an individual filter configured to reduce the measurement noises according to a working frequency or a working frequency range. In some embodiments, a noise filtering unit can include a band-stop filter configured to block signals having frequencies within a stopband around a central frequency and can attenuate a range of frequencies corresponding to the measurement noise. In some embodiments, a noise filtering unit can include a notch filter, which is a particular type of band-stop filter having a narrow stopband. That is, the notch filter is configured to block signals having frequencies within the narrow stopband around a central frequency.

As shown in FIG. 3A, an output, a_{f}, of the noise filter 312, the measured yaw angle ψₘ, and the measured angular velocity ωₘ are input to the observer system 320, which runs an estimation algorithm, such as an Extended Kalman Filter (EKF), over these inputs, based at least in part on the plurality models described above. The outputs of the observer system 320 constitute the outputs of the entire estimating system 300, including the estimated attitude \hat{R}. Consistent with embodiments of the disclosure, the plurality of models used in the observer system 320 can include an attitude kinematic model, a filter model, and/or one or more measuring device models. As described above, the filter model and/or the one or more measuring device models can be integrated in the state model for the mobile body and the filter model is configured to model states of the noise filter.

As described above, the noise filter 312 may work according to one or more working frequencies. In some embodiments, since the mobile body is in a three-dimension (3D) space, the vibration noises may include a vibration noise component in each of three directions. Therefore, the noise filter 312 can include three channels, each configured to filter out one vibration noise component. To effectively filter out the vibration noises, the working frequency of a channel of the noise filter 312 should be equal to or close to a characteristic frequency of the corresponding component of the vibration noises. For example, if the vibration noises include narrowband noises having a central frequency in one component, then the noise filter 312 can include a notch filter having a central frequency in a corresponding channel equal to or close to the central frequency of the narrowband noises. To allow the noise filter 312 to work properly, the frequency estimation system 330 can be configured to estimate one or more characteristic frequencies of the vibration noises, collectively denoted as f and referred to as the “characteristic frequency” of the vibration noises, for using by the noise filter 312 to set as the one or more working frequencies. In some embodiments, the frequency estimation system 330 uses the estimated attitude \hat{R} and the difference between the measured acceleration aₘ and the measured translational acceleration a_{cm} as inputs, and outputs an estimated characteristic frequency \hat{f}, also simply referred to as an “estimated frequency,” of the vibration noises. In the figure, the dashed arrows with symbol \hat{f} near the arrow end indicate an association with the estimated frequency \hat{f}.

The plurality of models consistent with the disclosure are described in more detail below. To obtain the state model, models for different measuring devices and the noise filter 312 can be established first and then combined to form the state model. The gyroscope 122 can be modeled using a gyroscope noise model, which describes a relationship between the measured angular velocity ωₘ and an actual angular velocity ω of the mobile body. The gyroscope noise model can be expressed as follows:

ωₘ=ω+b+nᵣ (2)

\dot{b}=n_{w} (3)

where b denotes a bias of the gyroscope 122, which reflects a random-walk shift of the gyroscope 122 driven by a Gaussian white noise n_{w}, and \dot{b} denotes the derivative of b with respect to time. Symbols nᵣ denotes a measurement noise, which is assumed to be Gaussian white.

The accelerometer 124 can be modeled using an accelerometer noise model, which describes a relationship between the measured acceleration aₘ, the measured translational acceleration a_{cm}, and the gravitational acceleration g, all expressed in the body coordinate system of the mobile body, such as the body coordinate system of the gimbal 120. The accelerometer noise model can be expressed as follows:

aₘ=−g+a_{cm}+d+nₐ (4)

where d denotes the vibration noise, which, as described above, is caused by the vibration of the mobile body and can be a non-Gaussian white noise. Further, nₐ denotes a Gaussian white noise in the measurement by the accelerometer 124, which reflects the random measurement noise in measuring the acceleration. Eq. (4) indicates that the accelerometer 124 measures all forces acted on the accelerometer 124 (and hence on the mobile body) but gravity (gravitational acceleration). This agrees with two common facts: 1) a free falling accelerometer leads to zero measurements; and 2) a static accelerometer reads an acceleration that is opposite to gravity.

In the geodetic coordinate system, the gravitational acceleration g is a constant vector pointing in the negative Z′ direction. However, in the body coordinate system of the mobile body, the gravitational acceleration g is a vector having a constant length but a direction dependent upon the attitude of the mobile body. As described above, the measured translational acceleration a_{cm} can be obtained from the translational acceleration measurement device 116, such as a GPS receiver. As such, the non-Gaussian white noise d can be the major factor that affects the attitude estimation. Therefore, consistent with embodiments of the disclosure, the noise filter 312 is added to the estimating system 300 to filter out the noise d.

In some embodiments, a state space model can be used to model the noise filter 312, which can be described using the following filter state equations:

\dot{x}_{f}=Ax_{f}+B(aₘ−a_{cm})

a_{f}=Cx_{f}+D(aₘ−a_{cm}) (5)

where x_{f} denotes a state of the filter state equations and \dot{x}_{f} denotes a derivative of x_{f} with respect to time. Symbols A, B, C, and D are coefficient matrices of the filter model represented by Eq. (5), and the dimensions of these coefficient matrices depend on an order l and a number of channels of the noise filter 312. As described above, for an estimation in the 3D space, the noise filter 312 can include three channels, each corresponding to one of the three directions in the 3D space. In this scenario, A∈ [symbol] ^{3l×3l}, B∈ [symbol] ^{3l×3l}, C∈ [symbol] ^{3l×3l}, D∈ [symbol] ^{3l×3l}. As shown in Eq. (5), the input of the noise filter 312 is the difference between the reading of the accelerometer 124, i.e., aₘ, and the reading of the translational acceleration measurement device 116, i.e., a_{cm}. An output of the noise filter 312, denoted as filter output a_{f}, corresponds to a filtered accelerometer reading. When the noise filter 312 is properly designed, the filter output a_{f} can be equal to or close to nₐ−g. That is, the non-Gaussian white noise d can be eliminated or reduced (compare to Eq. (4)).

As described above, including the noise filter 312, such as a notch filter, in the estimating system 300 can filter out the vibration noise b. However, this may also introduce delay to the input signal (e.g., accelerometer raw measurements corrected by translational acceleration), which in turn may lead to overshoot or even divergence in attitude control. To eliminate the delay, the added noise filter can be regarded as a part of the original system, which leads to an augmented system, and then their dynamics can be explicitly considered in the state observer, as described in the present disclosure. If the noise filter is linear, the augmented system will remain observable and the resulting Kalman filter will therefore converge to ground truth state. Due to the attenuation of the noise filter 312, the vibration noise shows no effect on the filter output and can be removed from the accelerometer model in Eq. (4).

In some embodiments, in addition to the estimated attitude \hat{R}, outputs of the observer system 320 can also include an estimated bias, \hat{b}, of the gyroscope 122 and an estimated filter output, â_{f}, of the noise filter 312. In some embodiments, the observer system 320 does not directly calculate the estimated attitude \hat{R}, the estimated bias \hat{b}, and the estimated filter output â_{f}. Instead, the observer system 320 can be designed to calculate (predict and update) certain intermediate states—δθ, Δb, and Δx_{f}, and then calculate the final outputs \hat{R}, \hat{b}, and â_{f} based on estimated values, δ\hat{θ}, Δ\hat{b}, and Δ\hat{x}_{f}, of the intermediate states. In this disclosure, δθ is an axis-angular representation of the difference, also referred to as an “attitude deviation,” between the estimated attitude \hat{R} of the mobile body and the actual attitude R of the mobile body, Δb denotes a difference between an estimated bias, \hat{b}, of the gyroscope 122 and the actual bias b of the gyroscope 122, and is also referred to as a “bias deviation” of the gyroscope 122, and Δx_{f} denotes a difference between an estimated filter state, \hat{x}_{f}, of the noise filter 312 and the actual filter state x_{f}, i.e.:

Δx_{f}=x_{f}−\hat{x}_{f} (6)

and is also referred to as a “filter state deviation.” In this disclosure, the attitude, the bias, and the filter output are also referred to as primal states associated with the mobile body, and the attitude deviation, the bias deviation, and the filter state deviation are also referred to as error states associated with the mobile body.

Consistent with the above-described two-step process, in some embodiments, as shown in FIG. 3A, the observer system 320 includes an error state estimation sub-system 322 configured to estimate the error states and a primal state estimation sub-system 324 configured to estimate the primal states based at least in part on the estimated error states, which are then output as the final outputs of the observer system 320. In some embodiments, with the inputs ωₘ, ψₘ, and a_{f}, an error state model describing the relationships among the error states is fed into an EKF in the error state estimation sub-system 322 to obtain the estimated error states δ\hat{θ}, Δ\hat{b}, and Δ\hat{x}_{f}, and the estimated error states δ\hat{θ}, Δ\hat{b}, and Δ\hat{x}_{f} are then processed in the primal state estimation sub-system 324 to produce the estimated primal states, i.e., the outputs \hat{R}, \hat{b}, and â_{f}. Since the observer system 320 indirectly estimates the primal states by first estimating the error states and then calculating the estimated primal states based on the estimated error states, the entire filtering process including the EKF in the error state estimation sub-system 322 and the process in the primal state estimation sub-system 324 can be referred to as an indirect EKF process.

The state model discussed above can include process models for the states, such as the error states and the primal states, and observing models for observables, such as observables associated with the error states and the primal states, as described in more detail below. In order to apply the EKF to the state model, the state model can be described as sets of differential equations, including, for example, a first set of state equations describing the process model for the error states and a second set of equations describing the observing model for the error states, as described in more detail below.

The error states include δθ, Δb, and Δx_{f} described above. The differential equations about δθ and Δb can be as follows:

δ\dot{θ}=−\hat{ω}ₓδθ−Δb−nᵣ (7)

Δ\dot{b}=n_{w} (8)

where \hat{ω}ₓ is an estimation of ωₓ, and ωₓ is defined as:

$${ω}_{x} {=}^{Δ} [ \begin{matrix}0 & {ω}_{z} & - {ω}_{y} \\ - {ω}_{z} & 0 & {ω}_{x} \\ {ω}_{y} & - {ω}_{x} & 0\end{matrix} ] = {R}^{T} \dot{R} \qquad ( 9 )$$

where ωₓ, ω_{y}, and ω_{z} are the measured angular velocities about the X-axis, the Y-axis, and the Z-axis of the body coordinate system, respectively, e.g., the components of ωₘ measured by the gyroscope 122. Eq. (9) corresponds to the attitude kinematic model described above.

In some embodiments, to obtain the differential equation for Δx_{f}, δθ can be approximated. In this disclosure, \hat{R} and δθ can be defined as follows:

$$\begin{matrix}\hat{R} {=}^{Δ} [ \begin{matrix}{\hat{R}}_{11} & {\hat{R}}_{12} & {\hat{R}}_{13} \\ {\hat{R}}_{21} & {\hat{R}}_{22} & {\hat{R}}_{23} \\ {\hat{R}}_{31} & {\hat{R}}_{32} & {\hat{R}}_{33}\end{matrix} ] = {R}^{T} \dot{R} & ( 10 ) \\ δθ {=}^{Δ} [ \begin{matrix}{δθ}_{1} \\ {δθ}_{2} \\ {δθ}_{3}\end{matrix} ] & ( 11 )\end{matrix}$$

Further, the difference between the actual attitude R and the estimated attitude \hat{R} is denoted as δR, which is also an error state and can be regarded as a rotation from the estimated attitude \hat{R} to the actual attitude R. Hence, the relationship between the estimated attitude \hat{R} and the actual attitude R can be expressed as follows:

R=\hat{R}·δR (12)

The rotation δR can be expressed in terms of δθ, as follows:

$$δ R = exp ( {δθ}_{x} ) \approx [ \begin{matrix}1 & - {δθ}_{3} & {δθ}_{2} \\ {δθ}_{3} & 1 & - {δθ}_{1} \\ - {δθ}_{2} & {δθ}_{1} & 1\end{matrix} ] = {I}_{3 \times 3} + {( δθ )}_{x} \qquad ( 13 )$$

As described above, the gravitational acceleration g in the body coordinate system depends on the attitude of the mobile body. As such, in the body coordinate system, the gravitational acceleration g can be expressed as follows:

$$g = {R}^{T} [ \begin{matrix}0 \\ 0 \\ 1\end{matrix} ] \qquad ( 14 )$$

Substituting Eqs. (12) and (13), and then Eq. (10), into Eq. (14) results in:

$$g = {( \hat{R} \cdot δ \hat{ R} )}^{T} [ \begin{matrix}0 \\ 0 \\ 1\end{matrix} ] = [ \begin{matrix}{\hat{R}}_{31} + {\hat{R}}_{32} \cdot {δθ}_{3} - {\hat{R}}_{33} \cdot {δθ}_{2} \\ - {\hat{R}}_{31} \cdot {δθ}_{3} + {\hat{R}}_{32} + {\hat{R}}_{33} \cdot {δθ}_{1} \\ {\hat{R}}_{31} \cdot {δθ}_{2} - {\hat{R}}_{32} \cdot {δθ}_{1} + {\hat{R}}_{33}\end{matrix} ] \qquad ( 15 )$$

Using −g as the input of the noise filter, the first one of the filter the state equations in Eq. (5) can be rewritten as follows:

$$\begin{matrix}{\dot{x}}_{f} = {Ax}_{f} - B [ \begin{matrix}{\hat{R}}_{31} + {\hat{R}}_{32} \cdot {δθ}_{3} - {\hat{R}}_{33} \cdot {δθ}_{2} \\ - {\hat{R}}_{31} \cdot {δθ}_{3} + {\hat{R}}_{32} + {\hat{R}}_{33} \cdot {δθ}_{1} \\ {\hat{R}}_{31} \cdot {δθ}_{2} - {\hat{R}}_{32} \cdot {δθ}_{1} + {\hat{R}}_{33}\end{matrix} ] \\ = {Ax}_{f} - B ( [ \begin{matrix}0 & - {\hat{R}}_{33} & {\hat{R}}_{32} \\ {\hat{R}}_{33} & 0 & - {\hat{R}}_{31} \\ - {\hat{R}}_{32} & {\hat{R}}_{31} & 0\end{matrix} ] [ \begin{matrix}{δθ}_{1} \\ {δθ}_{2} \\ {δθ}_{3}\end{matrix} ] + [ \begin{matrix}{\hat{R}}_{31} \\ {\hat{R}}_{32} \\ {\hat{R}}_{33}\end{matrix} ] ) \\ = {Ax}_{f} - B ( M \cdot δθ + {\hat{R}}^{T} {e}_{3} )\end{matrix} \qquad ( 16 )$$

where e₃=[0 0 1]^{T}, and

$$M {=}^{Δ} [ \begin{matrix}0 & - {\hat{R}}_{33} & {\hat{R}}_{32} \\ {\hat{R}}_{33} & 0 & - {\hat{R}}_{31} \\ - {\hat{R}}_{32} & {\hat{R}}_{31} & 0\end{matrix} ] \qquad ( 17 )$$

Subjecting Eq. (6) to differentiation with respect to time and substituting Eq. (16) into the differentiated equation results in the differentiation equation for Δx_{f} as follows:

$$\begin{matrix}Δ {\dot{x}}_{f} = {\dot{x}}_{f} - {{x}^{\dot{\hat{}}}}_{f} \\ = A Δ {x}_{f} - B ( M \cdot δθ - {n}_{a} )\end{matrix} \qquad ( 18 )$$

Eqs. (7), (8), and (18) are the first set of state equations of the process model for the error states consistent with the disclosure, i.e., the process model of the system including the noise filter. These equations can be put together and written in the matrix form of one equation, as follows:

$$[ \begin{matrix}\dot{δθ} \\ \dot{Δ b} \\ Δ {\dot{x}}_{f}\end{matrix} ] = [ \begin{matrix}- {\hat{ω}}_{\times } & - {I}_{3 \times 3} & {0}_{3 \times ( 3 l )} \\ {0}_{3 \times 3} & {0}_{3 \times 3} & {0}_{3 \times ( 3 ι )} \\ - B \cdot M & {0}_{( 3 l ) \times 3} & A\end{matrix} ] [ \begin{matrix}δ θ \\ Δ b \\ Δ {x}_{f}\end{matrix} ] + [ \begin{matrix}{I}_{3 \times 3} & {0}_{3 \times 3} & {0}_{3 \times 3} \\ {0}_{3 \times 3} & {I}_{3 \times 3} & {0}_{3 \times 3} \\ {0}_{3 l \times 3} & {0}_{3 l \times 3} & B\end{matrix} ] [ \begin{matrix}- {n}_{r} \\ {n}_{w} \\ {n}_{a}\end{matrix} ] \qquad ( 19 )$$

where l denotes the order of the noise filter 312. Denoting X̅≙=[δθ Δb Δx_{f}]^{T}, i.e., the state of the above state equation, then \overline{\dot{X}}=[δ\dot{θ} Δ\dot{b} Δ\dot{x}_{f}]^{T}. Further, the other three matrices/vector in the above equation can be denoted as F̅, B̅_{w}, and w̅, respectively. As such, the state equation Eq. (19) can be expressed in a simpler form as follows:

\overline{\dot{X}}=F̅X̅+B̅_{w}w̅ (20)

where w̅ is the total noise in the process model and satisfies w̅˜ [symbol] (0, Q̅), which means that the noise w̅ in the model is a Gaussian white noise having an average value of 0 and a covariance matrix Q̅.

As mentioned above, the observing model of the state model can include a set of state equations relating the observables to the states, which will be described in more detail below. In some embodiments, the yaw angle ψ can be the observable of the entire estimating system 300, which can be directly measured using, e.g., the electronic compass 126 and may only include a Gaussian white noise n_{y}, i.e.:

ψₘ=ψ+n_{y} (21)

where ψₘ denotes a measured yaw angle. Therefore, a quantity associated with the yaw angle ψ can be used as an observable of the state model. Further, since the filter output a_{f} of the noise filter 312 is an input to the observer system 320 and can be measured, a quantity associated with the filter output a_{f} can be used as another observable of the state model, as described in more detail below.

In some embodiments, the observables in the observing model of the state model can include a measured difference between the measured yaw angle ψₘ and an estimated yaw angle \hat{ψ}. This measured difference can be referred to as a “measured yaw angle deviation,” and can be denoted as Δψₘ (=ψₘ−\hat{ψ}). The observables in the observing model can further include a measured difference between a measured filter output a_{fm} and the estimated filter output â_{f}. This measured difference can be referred to as a “measured filter output deviation,” and can be denoted as Δa_{fm} (=a_{fm}−â_{f}). The measured difference Δψₘ can be regarded as a measured value of the difference between the actual yaw angle ψ and the estimated yaw angle \hat{ψ}, where the difference can be denoted as Δψ(=ψ−\hat{ψ}=Δψₘ−n_{y}). Similarly, the measured different Δa_{fm} can be regarded as a measured value of the difference between the actual filter output a_{f} and the estimated filter output â_{f}, where the difference can be denoted as Δa_{f} (=a_{f}−â_{f}).

In some embodiments, the yaw angle ψ of the mobile body can be expressed in terms of the attitude R of the mobile body as follows:

$$ψ = - arctan ( \frac{{e}_{1}^{T} R {e}_{2}}{{e}_{2}^{T} R {e}_{2}} ) \qquad ( 22 )$$

where e₁=[1 0 0]^{T} and e₂=[0 1 0]^{T}. Correspondingly, the estimated yaw angle \hat{ψ} can be expressed as:

$$\hat{ψ} = - arctan ( \frac{{e}_{1}^{T} \hat{R} {e}_{2}}{{e}_{2}^{T} \hat{R} {e}_{2}} ) \qquad ( 23 )$$

Therefore, the difference Δψ can be expressed as follows:

$$Δ ψ = arctan ( \frac{{e}_{1}^{T} \hat{R} {e}_{2}}{{e}_{2}^{T} \hat{R} {e}_{2}} ) - arctan ( \frac{{e}_{1}^{T} R {e}_{2}}{{e}_{2}^{T} R {e}_{2}} ) \qquad ( 24 )$$

Taking partial derivation of Eq. (24) with respect to δθ and omitting high-order items produce:

$$\frac{\partial ( Δ ψ )}{\partial ( δθ )} = [ \frac{{\hat{R}}_{23} \cdot {\hat{R}}_{12} - {\hat{R}}_{13} \cdot {\hat{R}}_{22}}{{\hat{R}}_{12}^{2} + {\hat{R}}_{22}^{2}} 0 \frac{{\hat{R}}_{11} \cdot {\hat{R}}_{22} - {\hat{R}}_{21} \cdot {\hat{R}}_{12}}{{\hat{R}}_{12}^{2} + {\hat{R}}_{22}^{2}} ] {=}^{Δ} N \qquad ( 25 )$$

Combining Eqs. (21) and (25) gives the differential equation for Δψₘ as follows:

Δψₘ=N·δθ+n_{y} (26)

The differential equation for the filter output a_{f} can be derived from the second equation in the filter state equation Eq. (5). Similar to the first equation in the filter state equation Eq. (5) that is rewritten as Eq. (16), the expression for the filter output a_{f} can also be rewritten as follows:

a_{f}=Cx_{f}−D(M·δθ+\hat{R}e₃) (27)

Combining Δa_{fm}=a_{fm}−â_{f} and the above equation produces the differential equation for Δa_{fm}, as follows:

Δa_{fm}=CΔx_{f}−DM·δθ+Dnₐ (28)

Eqs. (26) and (28) are the differential equations of the observing model for the error states consistent with the disclosure, i.e., the observing model of the system including the noise filter. These equations can be put together and written in the matrix form of one equation, as follows:

$$[ \begin{matrix}Δ {a}_{f m} \\ Δ {ψ}_{m}\end{matrix} ] = [ \begin{matrix}- D \cdot M & {0}_{3 \times 3} & C \\ N & {0}_{1 \times 3} & {0}_{1 \times 3 l}\end{matrix} ] [ \begin{matrix}δ θ \\ Δ b \\ Δ {x}_{f}\end{matrix} ] + [ \begin{matrix}D & {0}_{3 \times 1} \\ 0 & 1\end{matrix} ] [ \begin{matrix}{n}_{a} \\ {n}_{y}\end{matrix} ] \qquad ( 29 )$$

The observable vector ([Δa_{fm} Δψₘ]^{T}) in Eq. (29) can be denoted as Z̅, the coefficient matrices in Eq. (29) can be denoted as H̅ and D̅ᵥ, respectively, and the noise matrix ([nₐ n_{y}]^{T}) in Eq. (29) can be denoted as v̅. Thus, the state equation Eq. (29) can be expressed in a simpler form as follows:

Z̅=H̅X̅+D̅ᵥv̅ (30)

where v̅ is the total noise in the observing model and satisfies v̅˜ [symbol] (0, [symbol] ), which means that the noise v̅ in the model is a Gaussian white noise having an average value of 0 and a covariance matrix [symbol] .

Consistent with embodiments of the disclosure, as seen from the state equations Eqs. (19) and (29), the vibration noise d can be filtered out and the state model can include the filter model integrated therein. In some embodiments, the state equations (19) and (29) can be fed into an EKF algorithm in the error state estimation sub-system 322 to predict and update the error states δθ, Δb, and Δx_{f} iteratively. The estimated values of the error states δθ, Δb, and Δx_{f} at each iteration of the EKF algorithm are fed to the primal state estimation sub-system 324 to produce the estimated values of the primal states R, b, and a_{f} according to the relationships between the error states and the primal states described above.

In the description above, the derivation and final expressions of the state equations for processing by the EKF algorithm are written in the continuous time domain. To be supplied to the EKF algorithm for estimating the states at various time points, the continuous time domain equations may need to be further rewritten in the discrete time domain. In the discrete time domain equations discussed below, a quantity (e.g., a variable, a parameter, or a coefficient) will be denoted using the same symbol as in the continuous time domain equations discussed above, with an additional subscript k (or k−1, k+1, etc.) to denote the value of such quantity at the k-th (or (k−1)-th, (k+1)-th, etc.) time step, i.e., the k-th (or (k−1)-th, (k+1)-th, etc.) iteration in the estimating process. Further, the above description regarding the estimating system 300, the plant system 310, the observer system 320, the error state estimation sub-system 322, the primal state estimation sub-system 324, and the frequency estimation system 330 still applies in the discrete time domain description below.

In the discrete time domain, the gyroscope noise model can be expressed as follows:

ωₘ_{ₖ}=ωₖ+bₖ+nᵣ_{ₖ} (31)

bₖ=bₖ₋₁+n_{w}_{_{k−1}}Δt (32)

where Δt denotes the sampling time, i.e., the time difference (time period) between two successive time steps (iterations). Eq. (9) above corresponds to the attitude kinematic model describing the relationship between ωₓ and R, which can be rewritten as:

\dot{R}=Rωₓ (33)

In the discrete time domain, this state equation of R can be written as:

Rₖ=Rₖ₋₁ exp((ωₖ₋₁)ₓΔt) (34)

Similarly, the accelerometer noise model in the discrete time domain can be expressed as follows:

aₘ_{ₖ}=−gₖ+a_{cm}_{ₖ}+dₖ+nₐ_{ₖ} (35)

where gₖ=Rₖ^{T}e₃. The yaw angle in the discrete time domain can be expressed as follows:

$${ψ}_{{m}_{k}} = {ψ}_{k} + {n}_{{y}_{k}} where \\ {ψ}_{k} = - arctan ( \frac{{e}_{1}^{T} {R}_{k} {e}_{2}}{{e}_{2}^{T} {R}_{k} {e}_{2}} ) . \qquad ( 36 )$$

Further, the noise filter model in the discrete time domain can be expressed as follows:

x_{f}_{ₖ}=Ax_{f}_{_{k−1}}+B(aₘ_{_{k−1}}−a_{cm}_{_{k−1}}) (37a)

a_{f}_{ₖ}=Cx_{f}_{ₖ}+D(aₘ_{ₖ}−a_{cm}_{ₖ}) (37b)

The above state equations for the augmented system (with noise filter) in the discrete time domain are summarized as follows (with the vibration noise d filtered out):

Rₖ=Rₖ₋₁ exp((ωₖ₋₁)ₓΔt) (38a)

ωₖ₋₁=ωₘ_{_{k−1}}−bₖ₋₁−nᵣ_{_{k−1}}

bₖ=bₖ₋₁+n_{w}_{_{k−1}}Δt (38b)

x_{f}_{ₖ}=Ax_{f}_{_{k−1}}+B(aₘ_{_{k−1}}−a_{cm}_{_{k−1}}) (38c)

aₘ_{_{k−1}}=−gₖ+a_{cm}_{_{k−1}}+nₐ_{_{k−1}}

To linearize the augmented system, the augmented states can be predicted based on all the outputs up to k−1, by:

\hat{R}_{τ|k-1}=\hat{R}_{τ-1|k-1} exp((\hat{ω}_{τ-1|k-1})ₓΔt) (39a)

\hat{ω}_{τ-1|k-1}=ωₘ_{_{τ-1}}−\hat{b}_{τ-1|k-1}

\hat{b}_{τ|k-1}=\hat{b}_{τ-1|k-1} (39b)

\hat{x}_{f}_{_{τ|k−1}}=A\hat{x}_{f}_{_{τ-1|k−1}}−B\hat{R}_{τ-1|k-1}^{T}e₃ (39c)

where τ≥k, representing the τ-th time step (the τ-th iteration in the estimating process). Eqs. (39a), (39b), and (39c) represent that an estimated state at time step τ based on outputs up to k−1 can be predicted according to estimated states at time step τ−1 based on outputs up to k−1. For example, at time step k, the predictions are as follows:

\hat{R}_{k|k-1}=\hat{R}_{k-1|k-1} exp((\hat{ω}_{k-1|k-1})ₓΔt) (39d)

\hat{ω}_{k-1|k-1}=ωₘ_{_{k−1}}−\hat{b}_{k-1|k-1}

\hat{b}_{k|k-1}=\hat{b}_{k-1|k-1} (39e)

\hat{x}_{f}_{_{k|k−1}}=A\hat{x}_{f}_{_{k−1|k−1}}−B\hat{R}_{k-1|k-1}^{T}e₃ (39f)

To be subject to the error state estimation sub-system 322, the above primal states also need to be transformed to the error states, as follows:

δR_{τ} [symbol] \hat{R}_{τ|k-1}^{T}R_{τ} (40a)

Δb_{τ} [symbol] \hat{b}_{τ}−\hat{b}_{τ|k-1} (40b)

Δx_{f}_{_{τ}} [symbol] x_{f}_{_{τ}}−\hat{x}_{f}_{_{τ|k−1}} (40c)

Similarly, for time step k:

δRₖ=\hat{R}_{k|k-1}^{T}Rₖ (40d)

Δbₖ=bₖ−\hat{b}_{k|k-1} (40e)

Δx_{f}_{ₖ}=x_{f}_{ₖ}−\hat{x}_{f}_{_{k|k−1}} (40f)

Substituting Eqs. (38a), (38b), and (38c) and Eqs. (39a), (39b), and (39c) into Eqs. (40a), (40b), and (40c), respectively, gives the discrete time domain state equations of the process model as follows:

δR_{τ}=exp(−(\hat{ω}_{τ-1|k-1})ₓΔt)δR_{τ-1} exp((ω_{τ-1})ₓΔt) (41a)

Δb_{τ}=Δb_{τ-1}+n_{w}_{_{τ-1}}Δt (41b)

Δx_{f}_{_{τ}}=AΔx_{f}_{_{τ-1}}−B(\hat{R}_{τ-1|k-1}^{T}e₃)ₓδθ_{τ-1}+Bn_{α}_{_{τ-1}} (41c)

Substituting Eq. (13) into Eq. (41a) gives the state equation of δθ_{τ} as follows:

exp((δθ_{τ})ₓ)=exp(−(\hat{ω}_{τ-1|k-1})ₓΔt)(exp((δθ_{τ-1})ₓ) exp(−(\hat{ω}_{τ-1|k-1}−Δb_{τ-1}−n_{w}_{_{τ-1}})ₓΔt) (42)

In some embodiments, Eq. (42) can be computed by its linearized equation to form the EKF matrices. Since δθ_{τ} is a function of δθ_{τ-1}, Δb_{τ-1}, nᵣ_{_{τ-1}} as shown in Eq. (42), Eq. (42) can be linearized by taking partial differentiation of δθ_{τ} with respect to δθ_{τ-1}, Δb_{τ-1}, nᵣ_{_{τ-1}}, respectively, at a point p0 where (δθ_{τ-1}, Δb_{τ-1}, nᵣ_{_{τ-1}})=(0, 0, 0):

$$\begin{matrix}\frac{\partial {δθ}_{τ}}{\partial {δθ}_{τ - 1}} {\vert}_{{p}_{0}} = exp ( - {( {\hat{ω}}_{τ - 1 \vert k - 1} )}_{\times } Δ t ) & ( 43 a ) \\ \frac{\partial {δθ}_{τ}}{\partial Δ {b}_{τ - 1}} {\vert}_{{p}_{0}} = - M ( {\hat{ω}}_{τ - 1 \vert k - 1} Δ t ) Δ t \approx - {I}_{3 \times 3} Δ t & ( 43 b ) \\ \frac{\partial {δθ}_{τ}}{\partial {n}_{{r}_{τ - 1}}} {\vert}_{{p}_{0}} = - M ( {\hat{ω}}_{τ - 1 \vert k - 1} Δ t ) Δ t \approx - {I}_{3 \times 3} Δ t \\ where \\ M ( \cdot ) = I + ( \frac{1 - cos ‖ \cdot ‖}{‖ \cdot ‖} ) \frac{( \cdot )}{‖ \cdot ‖} + ( 1 - \frac{sin ‖ \cdot ‖}{‖ \cdot ‖} ) \frac{{( \cdot )}_{\times }^{2}}{{‖ \cdot ‖}^{2}} . & ( 43 c )\end{matrix}$$

Therefore, the linearized equation for δθ_{τ} is:

δθ_{τ}=exp(−(\hat{ω}_{τ-1|k-1})ₓΔt)δθ_{τ-1}−(Δb_{τ-1}+nᵣ_{_{τ-1}})Δt (44)

Further, considering Eq. (17), (\hat{R}_{τ-1|k-1}^{T}e₃)ₓ can be denoted as M_{τ-1}. The above equations, i.e., the augmented system represented by its error state, can be written in the matrix form as follows:

$$[ \begin{matrix}δ {θ}_{τ} \\ Δ {b}_{τ} \\ Δ {x}_{{f}_{τ}}\end{matrix} ] = [ \begin{matrix}exp ( - {( {\hat{ω}}_{τ 1 \vert k - 1} )}_{\times } Δ t ) & - {I}_{3 \times 3} Δ t & {0}_{3 \times ( 3 l )} \\ {0}_{3 \times 3} & {I}_{3 \times 3} & {0}_{3 \times ( 3 l )} \\ - B {M}_{τ 1} & {0}_{( 3 l ) \times 3} & A\end{matrix} ] [ \begin{matrix}δ {θ}_{τ 1} \\ Δ {b}_{τ 1} \\ Δ {x}_{{f}_{τ 1}}\end{matrix} ] + [ \begin{matrix}{I}_{3 \times 3} & {0}_{3 \times 3} & {0}_{3 \times 3} \\ {0}_{3 \times 3} & {I}_{3 \times 3} & {0}_{3 \times 3} \\ {0}_{3 l \times 3} & {0}_{3 l \times 3} & B\end{matrix} ] [ \begin{matrix}- {n}_{{r}_{τ 1}} Δ t \\ {n}_{{w}_{τ 1}} Δ t \\ {n}_{{a}_{τ 1}}\end{matrix} ] \qquad ( 45 )$$

This is the set of state equations of the process model for error states of the system including the noise filter expressed in the discrete time domain, which, similar to that in the continuous time domain case, can be expressed in a simpler form:

X̅_{τ}=F̅_{τ-1}X̅_{τ-1}+B̅_{w}w̅_{τ-1} (46)

where w̅_{τ-1}˜ [symbol] (0,Q̅_{τ-1}), and τ≥k−1, meaning that the system is defined from the previous time step k−1.

Although the error system, as expressed in, e.g., Eq. (45) or (46), is defined over all time steps τ≥k−1, only the current time step, i.e., τ=k, where \overline{\hat{X}}_{k-1|k-1}=0_{(3l+6)×1}, may be of interest in order to propagate the covariance matrix of the a-priori estimate as well as to update it. The error system expressed in, e.g., Eq. (45) or (46) is a time varying linear system and the standard Kalman filter can be applied. At τ=k, Eqs. (45) and (46) respectively become:

$$\begin{matrix}[ \begin{matrix}δ {θ}_{k} \\ Δ {b}_{k} \\ Δ {x}_{{f}_{k}}\end{matrix} ] = [ \begin{matrix}exp ( - {( {\hat{ω}}_{k - 1 \vert k - 1} )}_{\times } Δ t ) & - {I}_{3 \times 3} Δ t & {0}_{3 \times ( 3 l )} \\ {0}_{3 \times 3} & {I}_{3 \times 3} & {0}_{3 \times ( 3 l )} \\ - B {M}_{k - 1} & {0}_{( 3 l ) \times 3} & A\end{matrix} ] [ \begin{matrix}δ {θ}_{k - 1} \\ Δ {b}_{k - 1} \\ Δ {x}_{{f}_{k - 1}}\end{matrix} ] + [ \begin{matrix}{I}_{3 \times 3} & {0}_{3 \times 3} & {0}_{3 \times 3} \\ {0}_{3 \times 3} & {I}_{3 \times 3} & {0}_{3 \times 3} \\ {0}_{3 l \times 3} & {0}_{3 l \times 3} & B\end{matrix} ] [ \begin{matrix}- {n}_{{r}_{k - 1}} Δ t \\ {n}_{{w}_{k - 1}} Δ t \\ {n}_{{a}_{k - 1}}\end{matrix} ] & ( 47 ) \\ {\overline{X}}_{k} = {\overline{F}}_{k - 1} {\overline{X}}_{k - 1} + {\overline{B}}_{w} {\overline{w}}_{k - 1} & ( 48 )\end{matrix}$$

Further, the error state propagation and covariance matrix propagation can respectively be written as:

\overline{\hat{X}}_{k|k-1}=F̅ₖ₋₁\overline{\hat{X}}_{k-1|k-1}=0_{(3l+6)×1} (49a)

P̅_{k|k-1}=F̅ₖ₋₁P̅_{k-1|k-1}F̅ₖ₋₁^{T}+B̅_{w}Q̅ₖ₋₁B̅_{w}^{T} (49b)

where Eq. (49a) represents the prediction of the error state at iteration k according to the estimated error state at iteration k−1.

Further, as described above, the yaw angle ψ and the noise filter output a_{f} can be observables, i.e., measurements, of the augmented system. In the discrete time domain, the predicted noise filter output and the predicted yaw angle at time step k can be expressed as follows:

$$\begin{matrix}{\hat{a}}_{{f}_{k \vert k - 1}} = C {\hat{x}}_{{f}_{k \vert k - 1}} - D {\hat{R}}_{k \vert k - 1}^{T} {e}_{3} & ( 50 a ) \\ {\hat{ψ}}_{k \vert k - 1} = - arctan ( \frac{{e}_{1}^{T} {\hat{R}}_{k \vert k - 1} {e}_{2}}{{e}_{2}^{T} {\hat{R}}_{k \vert k - 1} {e}_{2}} ) & ( 50 b )\end{matrix}$$

Therefore, combining Eqs. (37) and (36) with Eqs. (50a) and (50b), respectively, the measured difference of the observables in the discrete time domain can be written as:

Δa_{f}_{ₖ}≙a_{f}_{ₖ}−â_{f}_{_{k|k−1}}=CΔx_{f}_{ₖ}−D(Mₖδθₖ−nₐ_{ₖ}) (51a)

Δψₘ_{ₖ}≙ψₘ_{ₖ}−\hat{ψ}_{k|k-1}=Nₖδθₖ+n_{y}_{ₖ} (51b)

where:

$$\begin{matrix}{M}_{k} = {( {\hat{R}}_{k \vert k - 1}^{T} {e}_{3} )}_{\times } & ( 52 a ) \\ {N}_{k} = [ \frac{{\hat{R}}_{{23}_{k}} \cdot {\hat{R}}_{{12}_{k}} - {\hat{R}}_{{13}_{k}} \cdot {\hat{R}}_{{22}_{k}}}{{\hat{R}}_{{12}_{k}}^{2} + {\hat{R}}_{{22}_{k}}^{2}} 0 \frac{{\hat{R}}_{{11}_{k}} \cdot {\hat{R}}_{{22}_{k}} - {\hat{R}}_{{21}_{k}} \cdot {\hat{R}}_{{12}_{k}}}{{\hat{R}}_{{12}_{k}}^{2} + {\hat{R}}_{{22}_{k}}^{2}} ] & ( 52 b )\end{matrix}$$

and \hat{R}ᵢⱼ_{ₖ} is the i-th row j-th column element of matrix \hat{R}_{k|k-1}. Eqs. (51a) and (51b) can be written in the matrix form as follows:

$$[ \begin{matrix}Δ {a}_{{f}_{k}} \\ Δ {ψ}_{{m}_{k}}\end{matrix} ] = [ \begin{matrix}- {DM}_{k} & {0}_{3 \times 3} & C \\ {N}_{k} & {0}_{1 \times 3} & {0}_{1 \times 3 l}\end{matrix} ] [ \begin{matrix}{δθ}_{k} \\ Δ {b}_{k} \\ Δ {x}_{{f}_{k}}\end{matrix} ] + [ \begin{matrix}D & {0}_{3 \times 1} \\ 0 & 1\end{matrix} ] [ \begin{matrix}{n}_{{a}_{k}} \\ {n}_{{y}_{k}}\end{matrix} ] \qquad ( 53 )$$

which, similar to that in the continuous time domain case, can be expressed in a simpler form:

$${\overline{Z}}_{k} = [ \begin{matrix}{a}_{{f}_{k}} - {\hat{a}}_{{f}_{k \vert k - 1}} \\ {ψ}_{{m}_{k}} - {\hat{ψ}}_{k \vert k - 1}\end{matrix} ] = {\overline{H}}_{k} {\overline{X}}_{k} + {\overline{D}}_{v} {\overline{v}}_{k} \qquad ( 54 )$$

where v̅ₖ˜ [symbol] (0, [symbol] ₖ), and Z̅ₖ represents output of the augmented system.

Recalling Eqs. (49a) and (49b), and following the standard Kalman filter procedure, the update of the augmented error state system can be obtained, for example, by the error state estimation sub-system 322, as follows:

S̅ₖ=H̅ₖP̅_{k|k-1}H̅ₖ^{T}+D̅ᵥ [symbol] ₖD̅ᵥ^{T} (55a)

K̅ₖ=P̅_{k|k-1}H̅ₖ^{T}S̅ₖ⁻¹ (55b)

\overline{\hat{X}}_{k|k}=\overline{\hat{X}}_{k|k-1}+K̅ₖ(Z̅ₖ−H̅ₖ\overline{\hat{X}}_{k|k-1})=K̅ₖZ̅ₖ (55c)

P̅_{k|k}=(I_{(3l+6)×(3l+6)}−K̅ₖH̅ₖ)P̅_{k|k-1} (55d)

where P̅_{k|k-1} and P̅_{k|k} denote the predicted (a priori) and the updated (a posteriori) estimate error covariance matrices, respectively, S̅ₖ denotes the innovation covariance, and K̅ₖ denotes the optimal Kalman gain. The updated estimated values of the error states at iteration k can each be obtained by taking one component of \overline{\hat{X}}_{k|k}:

δ\hat{θ}_{k|k}=Ē₁\overline{\hat{X}}_{k|k}=Ē₁K̅ₖZ̅ₖ (56a)

Δ\hat{b}_{k|k}=Ē₂\overline{\hat{X}}_{k|k}=Ē₂K̅ₖZ̅ₖ (56b)

Δ\hat{x}_{f}_{_{k|k}}=Ē₃\overline{\hat{X}}_{k|k}=Ē₃K̅ₖZ̅ₖ (56c)

where Ē₁=[I_{3×3} 0_{3×3} 0_{3×3l}], Ē₂=[0_{3×3} I_{3×3} 0_{3×3l}], and Ē₃=[0_{3l×3} 0_{3l×3} I_{3l×3l}].

When the updated error states are obtained, the primal states can be updated, for example, in the primal state estimation sub-system 324, according to the relationships between the error states and the primal states, Eqs. (40a)-(40f), and taking into consideration the relationship between δR and δθ as set forth in Eq. (13). In some embodiments, the updated estimated values of the primal states at iteration k can be represented by:

\hat{R}_{k|k}=\hat{R}_{k|k-1} exp(δθₓ)=\hat{R}_{k|k-1} exp((Ē₁K̅ₖZ̅ₖ)ₓ) (57a)

\hat{b}_{k|k}=\hat{b}_{k|k-1}+Δ\hat{b}_{k|k}=\hat{b}_{k|k-1}+Ē₂K̅ₖZ̅ₖ (57b)

\hat{x}_{f}_{_{k|k}}=\hat{x}_{f}_{_{k|k−1}}+Δ\hat{x}_{f}_{_{k|k}}=\hat{x}_{f}_{_{k|k−1}}+Ē₃K̅ₖZ̅ₖ (57c)

Algorithm 1 below summarizes an example of an indirect EKF algorithm with a noise filter consistent with embodiments of the disclosure. For simplification purposes, the algorithm below is expressed in terms of the primal states, with the interim processes for the error states omitted.

Algorithm 1 Indirect EKF algorithm with Noise Filter

```
Initialization: \hat{R}_{0|-1} = E[R₀]; \hat{b}_{0|-1} = E[R₀]; \hat{x}_{f}_{_{0|−1}} = x_{f}_{₀}; P_{0|-1} = P₀
  for k = 0, 1, 2, . . . , n do
    Receive the measurements aₘ_{ₖ} and ψₘ_{ₖ}
    Noise Filter
      Filter output:
        a_{f}_{ₖ} = Cx_{f}_{ₖ} + D(aₘ_{ₖ} − a_{c}_{ₖ})
      State update:
        x_{f}_{ₖ₊₁} = Ax_{f}_{ₖ} + B(aₘ_{ₖ} − a_{c}_{ₖ})
    Extended Kalman Filter
      Update:
        â_{f}_{_{k|k−1}} = C\hat{x}_{f}_{_{k|k−1}} − D\hat{R}_{f}_{_{k|k−1}}^{T} e₃
        ${\hat{ψ}}_{k \vert k - 1} = - arctan \frac{{e}_{1}^{T} {\hat{R}}_{k \vert k - 1} {e}_{2}}{{e}_{2}^{T} {\hat{R}}_{k \vert k - 1} {e}_{2}}$
        Z̅ₖ = [Δa_{f}_{ₖ} Δψₘ_{ₖ}]^{T}
        S̅ₖ = H̅ₖP̅_{k|k-1}H̅ₖ^{T} + D̅ᵥ [symbol] ₖD̅ᵥ^{T}
        K̅ₖ = P̅_{k|k-1}H̅ₖ^{T}S̅ₖ⁻¹
        \hat{R}_{k|k} = \hat{R}_{k|k-1}exp((Ē₁K̅ₖZ̅ₖ)ₓ)
        \hat{b}_{k|k} = \hat{b}_{k|k-1} + Ē₂K̅ₖZ̅ₖ
        \hat{x}_{f}_{_{k|k}} = \hat{x}_{f}_{_{k|k−1}} + Ē₃K̅ₖZ̅ₖ
        P̅_{k|k} = (I_{(3l+6)×(3l+6)} − K̅ₖH̅ₖ)P̅_{k|k-1}
      Predict:
        \hat{ω}_{k|k} = ωₘ_{ₖ} − \hat{b}_{k|k}
        \hat{R}_{k+1|k} = \hat{R}_{k|k} exp ((\hat{ω}_{k|k})ₓΔt)
        \hat{b}_{k+1|k} = \hat{b}_{k|k}
        \hat{x}_{f}_{_{k+1|k}} = A\hat{x}_{f}_{_{k|k}} − B\hat{R}_{k|k}^{T}e₃
        P̅_{k+1|k} = F̅ₖP̅ₖF̅ₖ^{T} + B̅_{w} [symbol] ₖB̅_{w}^{T}
end for
```

Note that Algorithm 1 is directed to an iterative calculation by a processor and is thus written in a manner that the state of the current time step is updated and then used to predict the state of the next time step.

The characteristic frequency/frequencies, e.g., dominant frequency/frequencies, of the vibration noises d may drift over time or over the environment, it may thus be needed to identify the characteristic frequency/frequencies in real time and tune the working frequency/frequencies of the noise filter 312, in order for the noise filter 312 to effectively filter out the vibration noises. As described above, the characteristic frequency/frequencies of the vibration noises can be estimated using the frequency estimation system 330. FIG. 3B is a schematic block diagram of the frequency estimation system 330 according to some embodiments of the disclosure. The frequency estimation system 330 includes a gravity calculation sub-system 332, a low-pass filter (LPF) 334, and an adaptive frequency estimation sub-system 336.

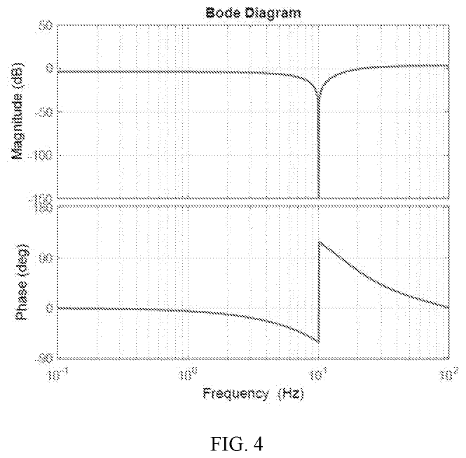

As shown in FIG. 3B, the estimated attitude \hat{R} is input into the gravity calculation sub-system 332 to calculate an estimated gravitational acceleration ĝ. The gravity calculation sub-system 332 can calculate the estimated gravitational acceleration ĝ based on a gravity model that describes a relationship between an attitude and a corresponding gravitational acceleration. In some embodiment, a measured gravitational acceleration gₘ is defined as gₘ [symbol] a_{cm}−aₘ. The difference between the estimated gravitational acceleration ĝ and the measured gravitational acceleration, which is defined as a measured noise dₘ, is input into the low-pass filter 334 to filter out high-frequency components of the measured noise dₘ, so as to obtain a main component, d̅, of the noise. In the example shown in FIG. 4 and described above, the vibration noises mainly include low-frequency noises. Therefore, the low-pass filter 334 can block high-frequency components of the measured noise dₘ, such as measurement noise n_{α} and other vibration noise components, and hence the main component d that is output by the low-pass filter 334 may mainly include the vibration noises. However, the present disclosure is not limited to the low-pass filter 334. Depending on the characteristics of the vibration noises and other noises, a different type of filter, e.g., a band-pass filter or a high-pass filter, can be used instead of the low-pass filter 334.

The output d̅ of the low-pass filter 334 is input into the adaptive frequency estimation sub-system 336. In some embodiments, the adaptive frequency estimation sub-system 336 can be configured to process d̅ to obtain the estimated frequency f according to the following equations (written in discrete time domain):

\hat{η}ₖ=2 cos(2π\hat{f}ₖΔt) (58)

εₖ(\hat{η}ₖ)=d̅ₖ+d̅ₖ₋₂−\hat{η}ₖd̅ₖ₋₁ (59)

\hat{η}ₖ₊₁=\hat{η}ₖ+λd̅ₖ₋₁εₖ(\hat{η}ₖ) (60)

where \hat{η} is an estimated value of an intermediate variable η that is associated with frequency f, and ε denotes a residual error for the intermediate variable η. Eq. (33) is a Least Mean Square (LMS) estimation of η in real time. Further, λ denotes an adaptation gain, which is an adjusting parameter that can be adjusted according to an amplitude of the vibration.

Algorithm 2 below summarizes the frequency estimation according to some embodiments of the disclosure.

Algorithm 2 Adaptive frequency estimator

```
Initialization: λ = λ₀, \hat{η}₀ = η₀
  for k = 2, 3, ..., n do
    dₘ_{ₖ} = aₘ_{ₖ} + ĝ_{k|k} − a_{cm}_{ₖ}
    d̅ₖ = LPF[dₘ_{ₖ}]
    ϵₖ = d̅ₖ + d̅ₖ₋₂ − \hat{η}ₖd̅ₖ₋₁
    \hat{η}ₖ₊₁ = \hat{η}ₖ + λd̅ₖ₋₁ϵₖ
  end for
```

As described above, in some embodiments, the vibration noise d in the accelerometer measurement, which represents the translational vibration of the mobile body, may have a narrow frequency range. As such, the noise filter 312 can include a notch filter to attenuate the vibration noise d. The transfer function of a notch filter in discrete time domain can be represented as:

$${G}_{f} ( z ) = \frac{{z}^{2} - 2 α cos ( {ω}_{0} Δ t ) z + {α}^{2}}{{z}^{2} - 2 β cos ( {ω}_{0} Δ t ) z + {β}^{2}} \qquad ( 61 )$$

where z denotes the [symbol] -transform variable, ω₀ denotes the dominant noise frequency, α and β denote damping ratio-like parameters that are used to tune the width and depth of the notch filter. FIG. 4 shows the Bode plot of an example notch filter with α=1, β=0.7, and ω₀=10 Hz.

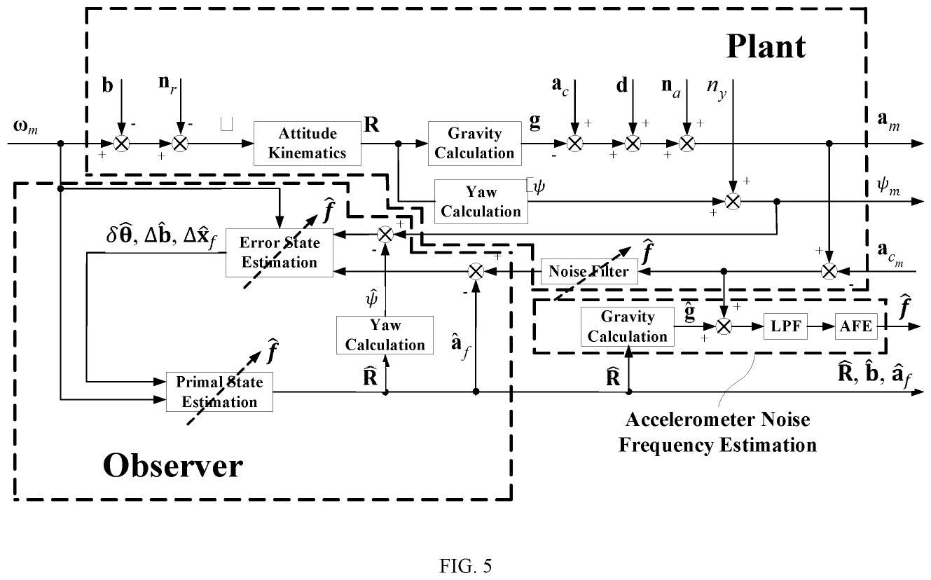

FIG. 5 is a schematic block diagram of an example of the estimating system according to some embodiments of the disclosure. More specifically, FIG. 5 schematically shows example of details of the estimating system 300 shown in FIGS. 3A and 3B and described above. Descriptions of components in FIG. 5 that are also shown in FIGS. 3A and 3B and described above are omitted here.

In FIG. 5, “Yaw Calculation” refers to a yaw calculation sub-system that is configured to calculate a yaw angle according to an input attitude. The yaw calculation sub-system can calculate the yaw angle based on a yaw model that describes a relationship between an attitude and a corresponding yaw angle. In the plant system that describes the actual processes relating different physical quantities, the yaw calculation sub-system describes a relationship between the actual attitude R and the actual yaw angle ψ. In the observer system, the yaw calculation sub-system can calculate the estimated yaw angle \hat{ψ} according to the estimated attitude \hat{R} output by the primal state estimation sub-system. The estimated yaw angle \hat{ψ} output by the yaw calculation sub-system in the observer system is then subtracted from the measured yaw angle ψₘ, and the subtraction result is used as one input to the error state estimation sub-system, as shown in FIG. 5, as described above.

Further, in FIG. 5, “Attitude Kinematics” in the plant system refers to an attitude kinematics sub-system relating the attitude R to the angular velocity ω, e.g., according to the attitude kinematic model described above, i.e., Eq. (9) or (33).

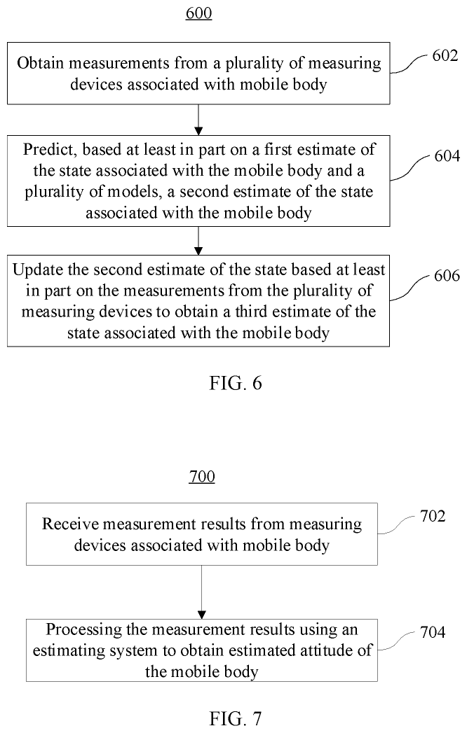

FIG. 6 is a flow chart schematically showing a method 600 for estimating a state associated with a mobile body according to some embodiments of the disclosure. The method 600 can be implemented, for example, in the controlling device 115 or the controlling device 121. The mobile body can be, for example, the UAV 110 or the gimbal 120 carried by the UAV 110.

As shown in FIG. 6, at 602, measurements, i.e., measurement results, from a plurality of measuring devices associated with the mobile body are obtained. The measuring devices are configured to measure physical quantities that are related to the attitude of the mobile body, and can include, for example, one or more of a gyroscope, an accelerometer, an electronic compass, and a translational acceleration measurement device. The gyroscope can be, for example, the gyroscope 117 or the gyroscope 122 depending on whether the mobile body is the UAV 110 or the gimbal 120. The accelerometer can be the accelerometer 118 or the accelerometer 124 depending on whether the mobile body is the UAV 110 or the gimbal 120. The electronic compass can be the electronic compass 119 or the electronic compass 126, and can be, for example, a magnetometer. The translational acceleration measurement device can be the translational acceleration measurement device 116. Correspondingly, the measurements can include, for example, one or more of the angular velocity of the mobile body measured by the gyroscope, the linear acceleration of the mobile body measured by the accelerometer, the Euler angle (such as the yaw angle) of the mobile body, and the translational acceleration measured by the translational acceleration measurement device. In the embodiments in which the mobile body is the gimbal 120, the Euler angle (such as the yaw angle) of the mobile body can be directly measured by the electronic compass 126 mounted on the gimbal 120, or can be indirectly measured by the electronic compass 119 mounted on the UAV 110. In some embodiments, the measurements from the accelerometer can be filtered using a noise filter, such as the noise filter 312.

At 604, based at least in part on a first estimate of the state associated with the mobile body and a plurality of models, a second estimate of the state associated with the mobile body is predicted. In some embodiments, the plurality of models can include, for example, an attitude kinematic model (such as the attitude kinematic model expressed as Eq. (9) or (33)), one or more measuring device models each modeling one of the measuring devices (such as a gyroscope model for the gyroscope (e.g., Eqs. (2) and (3) or Eqs. (31) and (32)) and/or an accelerometer model for the accelerometer (e.g., Eq. (4) or Eq. (35))), and/or a filter model for the noise filter (e.g., Eq. (5) or Eqs. (37a) and (37b)).

In some embodiments, the state can include a primal state associated with the mobile body and an error state associated with the mobile body. In some embodiments, the primal state can include, for example, an attitude of the mobile body, such as the attitude R described above, a bias associated with at least one of the plurality of measuring devices, and/or a filter state of the noise filter, such as the filter state x_{f} described above. In some embodiments, the at least one of the plurality of measuring devices includes, e.g., the gyroscope, and the bias can be associated with the gyroscope, such as the bias b described above.

In some embodiments, the error state can include an attitude deviation, such as the attitude deviation δR (or represented in the axis-angular form, δθ), reflecting a difference between the actual attitude and the estimated attitude of the mobile body, a bias deviation, such as the bias deviation Δb, reflecting a difference between the actual bias and the estimated bias of the at least one of the plurality of measuring devices, and a filter state deviation, such as the filter state deviation Δx_{f}, reflecting a difference between the actual filter state and the estimated filter state of the noise filter.

At 606, the second estimate of the state is updated based at least in part on the measurements from the plurality of measuring devices to obtain a third estimate of the state associated with the mobile body.

In some embodiments, the state model for the mobile body is subjected to an EKF algorithm to estimate the state, with one or more of the measurements being inputs in the estimation process. Such an estimation includes an iterative process, at each iteration of which the state is predicted based on estimated state in last iteration and then updated based on certain inputs. The updated state can be output as the estimated state of current iteration. In these embodiments, the first estimate of the state can be, for example, an updated state in a (k−1)-th iteration in the estimation process (k being an integer); the second estimate of the state can be, for example, a predicted state in a k-th iteration in the estimation process; and the third estimate of the state can be, for example, an updated state in the k-th iteration in the estimation process.

In some embodiments, predicting and/or updating the second estimate of the state can also be based at least in part on the measurements from the plurality of measuring devices. For example, the angular velocity of the mobile body measured by the gyroscope can be used in the prediction of the second estimate of the state. Further, the linear acceleration and/or the Euler angle, e.g., the yaw angle, of the mobile body can be used in the updating of the second estimate of the state.

As described above, the Euler angle of the mobile body can be directly or indirectly measured by the electronic compass. That is, depending on the connection relationship between the mobile body and the electronic compass, the electronic compass can measure the Euler angle of the mobile body if attached to the mobile body or an angle corresponding to the Euler angle of the mobile body if attached to another body not rigidly connected to the mobile body, such as a carrier carrying the mobile body. In the former scenario, the electronic compass can directly measure the Euler angle of the mobile body. In the latter scenario, the Euler angle of the mobile body can be obtained based on an Euler angle measured by the electronic compass and a relationship between the mobile body and the other body.

For example, in the embodiments where the gimbal 120 is the mobile body, the electronic compass can be the electronic compass 126 attached to the gimbal 120, or can be the electronic compass 119 attached to the UAV 110 carrying the gimbal 120. The gimbal 120 and the UAV 110 can be connected to each other through a joint motor. That is, the gimbal 120 can rotate with respect to the UAV 110 through the rotation of the joint motor. In this example, the Euler angle of the gimbal 120 can be obtained based on a UAV Euler angle of the UAV 110 measured by the electronic compass 119 and a motor angle of the joint motor. The motor angle represents the angle of the gimbal 120 rotated with respect to the UAV 110.

As described above, the measurements can include a translational acceleration, which, as described above, can be obtained by the translational acceleration measurement device. The translational acceleration measurement device can include a satellite navigation device, such as a Global Positioning System (GPS) receiver, a Global Navigation Satellite System (GLONASS) receiver, a Galileo navigation system receiver, and/or a BeiDou Navigation Satellite System (BeiDou) receiver.

As described above, the method for estimating the state associated with the mobile body can be based at least in part on a state model, which can include an error state model and a primal state model.

In some embodiments, the error state model can include a process model and an observing model. The process model of the error state model, also referred to as an “error state process model,” can be represented by a set of differential equations of the error states, which can be expressed in the continuous time domain as, e.g., Eq. (19) or Eq. (20), or be expressed in the discrete time domain as, e.g., Eq. (47) or Eq. (48). The observing model of the error state model, also referred to as an “error state observing model,” can be represented by a set of differential equations of the observables, which can be expressed in the continuous time domain as, e.g., Eq. (29) or Eq. (30), or be expressed in the discrete time domain as, e.g., Eq. (53) or Eq. (54).

Similarly, in some embodiments, the primal state model can include a process model, also referred to as a “primal state process model” (expressed as, e.g., Eqs. (38a)-(38c)) and an observing model, also referred to as a “primal state observing model” (expressed as, e.g., Eqs. (36) and (37b). The relationship between the error states and the primal states can be represented by, e.g., Eqs. (57a)-(57c) and in Algorithm 1 described above.

The error state model can be used in, e.g., the error state estimation sub-system 322, for predicting and updating the error state iteratively. In each iteration, the error state is predicted based at least in part on the estimated error state in last iteration, and the predicted error state is updated based on certain inputs, such as based at least in part on the measurements from the plurality of measuring devices. The updated error state is then output as the estimated error state of the current iteration. Similarly, the primal state model can be used in, e.g., the primal state estimation sub-system 324, for predicting and updating the primal state iteratively. In each iteration, the primal state is predicted based at least in part on the estimated primal state in last iteration, and the predicted primal state is updated based on certain inputs, such as based at least in part on the measurements from the plurality of measuring devices and the updated error state, i.e., the estimated error state of the current iteration. The updated primal state is then output as the estimated primal state of the current iteration.

That is, in some embodiments, the above-described prediction of the second estimate of the state associated with the mobile body can include predicting, based at least in part on a first estimate of the error state associated with the mobile body, a second estimate of the error state associated with the mobile body; and predicting, based at least in part on a first estimate of a primal state associated with the mobile body, a second estimate of the primal state associated with the mobile body. Similarly, the above-described updating of the second estimate of the state associated with the mobile body can include updating the second estimate of the error state to obtain a third estimate of the error state associated with the mobile body; and updating the second estimate of the primal state to obtain a third estimate of the primal state associated with the mobile body. In some embodiments, the third estimate of the error state, i.e., the estimated error state obtained by updating the second estimate of the error state, can be used in the updating of the second estimate of the primal state to obtain the third estimate of the primal state.

For example, at the k-th iteration in the estimation process, an updated error state of the (k−1)-th iteration, i.e., the first estimate of the error state above, can be used in predicting a predicted error state of the k-th iteration, i.e., the second estimate of the error state above. The prediction of the error state is described, for example, by Eq. (49a). In some embodiments, angular measurements from at least one of the plurality of measuring devices can also be used in this prediction. In some embodiments, the angular measurements can include the angular velocity measured by the gyroscope.

Further, the predicted error state of the k-th iteration can then be updated to obtain an updated error state of the k-th iteration, i.e., the third estimate of the error state above. The updating of the error state is described, for example, by Eq. (55c) as a whole, or Eqs. (56a)-(56c) for respective error states. In some embodiments, this updating can be based at least in part on the measurements from the plurality of measuring devices. For example, the updating of the predicted error state of the k-th iteration can be based at least in part on the Euler angle of the mobile body obtained directly or indirectly from the electronic compass and/or an acceleration representing a difference between the linear acceleration measured by the accelerometer and the translational acceleration measured by the translational acceleration measuring device. In some embodiments, the difference between the linear acceleration and the translational acceleration can be filtered by the noise filter before being used to update the second estimate of the error state.

Similar to the error state estimation described above, in the primal state estimation, an updated primal state of the (k−1)-th iteration, i.e., the first estimate of the primal state above, can be used in predicting a predicted primal state of the k-th iteration, i.e., the second estimate of the primal state above. The prediction of the primal state is described, for example, by Eqs. (39d)-(39f) or in the “Predict” section of Algorithm 1. In some embodiments, angular measurements from at least one of the plurality of measuring devices can also be used in this prediction. The angular measurements can include the angular velocity measured by the gyroscope.

Further, the predicted primal state of the k-th iteration can then be updated to obtain an updated primal state of the k-th iteration, i.e., the third estimate of the primal state above. The updating of the primal state is described, for example, by Eqs. (57a)-(57c) or in the “Update” section of Algorithm 1. In some embodiments, this updating can be based at least in part on the updated error state of the k-th iteration and/or the angular measurements from at least one of the plurality of measuring devices can also be used in this prediction, such as the angular velocity measured by the gyroscope.

In some embodiments, the updated primal state of the k-th iteration, after undergoing certain processes, can be used together with the measurements from the plurality of measuring devices in the updating of the predicted error state in the (k+1)-th iteration. That is, consistent with the disclosure, the error state estimation and the primal state estimation can form a cycle, in which the output from the error state estimation can serve as part of the input to the primal state estimation, and the output of the primal state estimation can serve as part of the input to the error state estimation.

As described above, the measurements from the accelerometer can be filtered by the noise filter, which can reduce a measurement noise, such as the vibration noise, associated with the accelerometer. To effectively filter out the measurement noise, the noise filter needs to work in correspondence with a frequency or a frequency range of the measurement noise, and hence the frequency or frequency range of the measurement noise may need to be estimated. The frequency estimation can be performed according to, for example, Eqs. (58)-(60) or Algorithm 2 described above.

For example, the noise filter can include a low-pass filter or a band-stop filter configured to attenuate a range of frequencies (stopband) corresponding to the measurement noise, and the range of frequencies corresponding to the measurement noise can be estimated. In some embodiments, estimating the range of frequencies corresponding to the measurement noise can be based at least in part on the estimated attitude of the mobile body and an unfiltered acceleration. The unfiltered acceleration refer to an acceleration before being subject to the noise filter and can include a difference between the linear acceleration of the mobile body measured by the accelerometer and the translational acceleration of the mobile body measured by the translational acceleration measurement device.

In some embodiments, the band-stop filter can include a notch filter which has a narrow stopband. To effectively filter out the measurement noise, the center frequency of the stopband may need to align with the center frequency of the range of frequencies corresponding to the measurement noise. Hence, the center frequency of the range of frequencies corresponding to the measurement noise may need to be estimated, which can also be based at least in part on the estimated attitude of the mobile body and the unfiltered acceleration.

The noise filtering, error state estimation, primal state estimation, and frequency estimation in the embodiments described above with reference to FIG. 6 are similar to those in other embodiments of the disclosure, and thus detailed description thereof is omitted.

FIG. 7 is a flow chart schematically showing a method 700 for estimating an attitude of a mobile body according to some embodiments of the disclosure. The method 700 can be implemented, for example, in the controlling device 115 or the controlling device 121. The mobile body can be, for example, the UAV 110 or the gimbal 120 carried by the UAV 110.

As shown in FIG. 7, at 702, measurement results from measuring devices associated with the mobile body are received. The process at 702 is similar to the process at 602 described above, and thus detailed description thereof is omitted.

At 704, the measurement results are processed using an estimating system to obtain an estimated attitude of the mobile body. In some embodiments, the estimating system includes a plant system including a noise filter and an observer system based on a state model. The state model includes a filter model integrated therein that models the noise filter. That is, the state model not only models states related to the attitude and noises of the mobile body, but also models the noise filter used to filter out at least a portion of the noises. The state model can include an error state model and a primal state model. The error state model can include an error state process model expressed, for example, in the continuous time domain as Eq. (19) or (20), or in the discrete time domain as Eq. (47) or (48). The error state model can further include an error state observing model expressed, for example, in the continuous time domain as Eq. (29) or (30), or in the discrete time domain as Eq. (53) or (54). The primal state model can include a primal state process model expressed, for example, as Eqs. (38a)-(38c) and a primal state observing model expressed, for example, as Eqs. (36) and (37b).

In some embodiments, the measurement results include a measured linear acceleration, e.g., from the accelerometer and the measured linear acceleration includes a vibration noise, which can be, for example, a non-Gaussian white noise. The noise filter can be configured to work according to a working frequency to filter out the vibration noise. The working frequency of the noise filter can be configured to be equal to or close to a characteristic frequency of the vibration noise. Therefore, the estimating system can further include a frequency estimation system configured to estimate the characteristic frequency of the vibration noise according to, e.g., Eqs. (58)-(60) or Algorithm 2. The estimated characteristic frequency can be used as the working frequency in the noise filter for the noise filter to obtain a filter output. That is, the measured linear acceleration can be processed using the noise filter according to the estimated characteristic frequency of the vibration noise to obtain the filter output.

In some embodiments, the vibration noise includes vibrations of various frequencies around a central frequency. In these embodiments, estimating the characteristic frequency of the vibration noise can include estimating the central frequency of the vibration noise using the frequency estimation system. The noise filter can include a band-stop filter configured to block a frequency band around the working frequency. The working frequency of the band-stop filter can be configured to be equal to or close to the estimated central frequency of the vibration noise obtained by the frequency estimation system.

In some embodiments, the vibration noise may include a narrow band, i.e., frequencies of the vibrations in the vibration noise may mostly be included in the narrow band. As such, a notch filter can be used as the noise filter, which is a particular type of the band-stop filter that has a narrow stopband.

In some embodiments, the vibration noise may have not only vibrations associated with one characteristic frequency, but multiple groups of vibrations each being associated with one characteristic frequency. To filter out such a vibration noise, the multiple characteristic frequencies may need to be estimated using the frequency estimation system. Correspondingly, the noise filter may include a set of noise filtering units each configured to work at a working frequency equal to or close to one of the estimated characteristic frequencies. Thus, the measured linear acceleration can be processed using the set of noise filtering units according to the estimated characteristic frequencies of the vibration noise to obtain the filter output.

The set of noise filtering units can be configured according to the characteristics of the vibration noise. For example, if the vibration noise includes multiple groups of vibrations each having a relatively wide frequency band, the set of noise filtering units can all be band-stop filters. As another example, if the vibration noise includes multiple groups of vibrations each having a relatively narrow frequency band, the set of noise filtering units can all be notch filters. As a further example, if the vibration noise includes one or more groups of vibrations each having a relatively wide frequency band and one or more groups of vibrations each having a relatively narrow frequency band, the set of noise filtering units can include one or more band-stop filters and one or more notch filters.

In some embodiments, the measurement results further include a measured translational acceleration from, e.g., the translational acceleration measurement device. The characteristic frequency of the vibration noise can be calculated based on both the measured linear acceleration and the measured translational acceleration. In some embodiments, a difference between the measured linear acceleration and the measured translational acceleration can be calculated, which can be regarded to as a measured gravitational acceleration. Instead of the measured linear acceleration, the measured gravitational acceleration can be input into the noise filter for processing according to the characteristic frequency of the vibration noise. Thus, the filter output can include a filtered gravitational acceleration.

Further, the frequency estimation system can process the measured gravitational acceleration and an estimated gravitational acceleration to obtain the estimated characteristic frequency, such as the estimated central frequency.

As described above, the state estimation, which includes estimation of the attitude, consistent with embodiments of the disclosure can include an iterative process. In some embodiments, an estimated attitude obtained in a previous iteration, i.e., a previous time point, such as the last iteration, can be processed to obtain the estimated gravitational acceleration for the current iteration, i.e., the current time point. In some embodiments, the previously-obtained estimated attitude can be processed based on a gravity model to obtain the estimated gravitation al acceleration.

In some embodiments, the frequency estimation system calculates a difference between the measured gravitational acceleration and the estimated gravitational acceleration as a measured value of the vibration noise. The frequency estimation system can further include a pre-processing filter and an adaptive frequency estimation sub-system. The measured vibration noise can be subject to the pre-processing filter to filter out a portion thereof and then processed by the adaptive frequency estimation sub-system to determine the characteristic frequency of the vibration noise. The adaptive frequency estimation can include, for example, the processing set forth in Eqs. (58)-(60) or Algorithm 2 described above. Further, the pre-processing filter can include, for example, a band-pass filter or a low-pass filter.

In some embodiments, the measurement results further include a measured angular velocity from, for example, the gyroscope, and a measured Euler angle, such as a measured yaw angle, from, for example, the electronic compass. The measured angular velocity, the filter output, and the measured Euler angle can be input to the observer system to obtain the estimated attitude. As described above, the state model is configured to model, for example, one or more states related to the attitude of the mobile body, one or more states related to the noise, and/or one or more states related to the noise filter. As described above, in some embodiments, some of the states can include an attitude deviation reflecting a difference between the actual attitude and the estimated attitude of the mobile body, a bias deviation reflecting a difference between an actual bias and an estimated bias of the gyroscope, a filter state deviation reflecting a difference between an actual filter state and an estimated filter state of the noise filter, an Euler difference reflecting a difference between a measured Euler angle, e.g., a measured yaw angle, and an estimated Euler angle, e.g., an estimated yaw angle, and a filter output difference reflecting a difference between the filter output and an estimated filter output. Since the states noted above all reflect differences between actual or measured values and estimated values, they are also referred to as “error states,” as described above.

In some embodiments, an EKF algorithm is applied to the filter output, the measured angular velocity, and the measured Euler angle of the mobile body to obtain the estimated attitude. That is, the EKF can be applied to the filter output, the measured angular velocity, and the measured Euler angle to predict and update one or more of the above-described error states modeled by the error state model. More specifically, the filter output difference, the Euler difference, and the measured angular velocity can be subjected to an error state estimation sub-system of the observer system to obtain an estimated attitude deviation, an estimated bias deviation, and an estimated filter state deviation. These estimated error states can then be further processed by a primal state estimation sub-system of the observer system to update the estimated attitude, the estimated bias, and the estimated filter output. Further, the updated estimated attitude can be processed by an Euler calculation sub-system of the observer system to update the estimated Euler angle, such as being processed by a yaw calculation sub-system of the observer system to update the estimated yaw angle.

In some embodiments, the state model, such as the error state model and/or the primal state model can be expressed as a set of state equations. One or more of the state equations consider the state of the noise filter. Therefore, during the attitude estimation process, the state of the noise filter can be updated.

The noise filtering, error state estimation, primal state estimation, and frequency estimation in the embodiments described above with reference to FIG. 7 are similar to those in other embodiments of the disclosure, and thus detailed description thereof is omitted.

Embodiments of the present disclosure, unless conflicting with each other, can be combined and/or some descriptions with respect to one embodiment can also be applied to another embodiment.

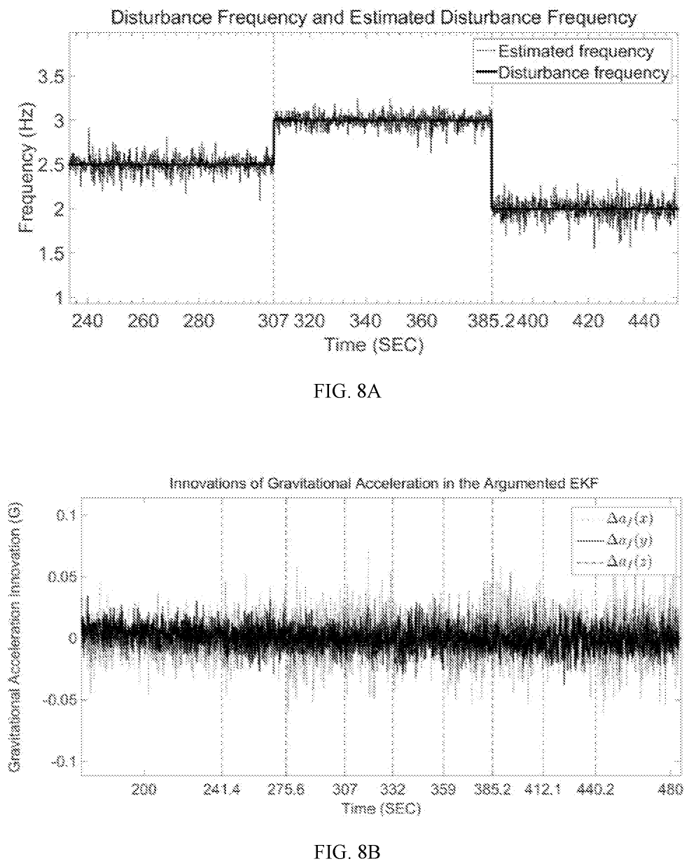

FIGS. 8A and 8B show results of an experiment performed on a gimbal. For simplification, the gimbal is kept still, and the stimulation and measurements are performed in the X-axis of the accelerometer connected to the gimbal. Specifically, a sinusoidal disturbance, i.e., a sinusoidal noise, with an amplitude of 0.5 g (“g” refers to the absolute value of the gravity) and a varying frequency is applied in the X-axis of the accelerometer. The frequency of the disturbance is initially set at 2.5 Hz, and changed to 3.0 Hz and 2.0 Hz at 307.0 s and 385.2 s, respectively. Further, a pitch angle of gimbal is also changed during the experiment. In particular, at 241.4 s, 332 s, and 412.1 s, the pitch angle of the gimbal is changed from 0° to −90°; and at 275.6 s, 359.0 s, and 440.2 s, the pitch angle of the gimbal is changed from −90° to 0°.

FIG. 8A shows the changes of the set disturbance frequency (stimulation) and the estimated frequency. As shown in FIG. 8A, the estimated frequency curve well matches the actual disturbance frequency curve. This indicates that the method consistent with the disclosure has a high accuracy and a high converging speed, and is well self-adaptive.

FIG. 8B shows EKF innovations of the gravitational acceleration (residuals between measured gravitational acceleration and estimated gravitational acceleration) in X-, Y-, and Z-axis directions, respectively. As shown in FIG. 8B, the innovations of the gravitational acceleration in all directions maintain a small value around zero, even when the disturbance frequency is being changed or when the gimbal is being rotated. This indicates that the method consistent with the disclosure is accurate in estimating attitude.

In view of the above, according to the methods and devices consistent with the disclosure, variable noise can be adaptively filtered while precise attitude estimation with negligible delay can be provided.

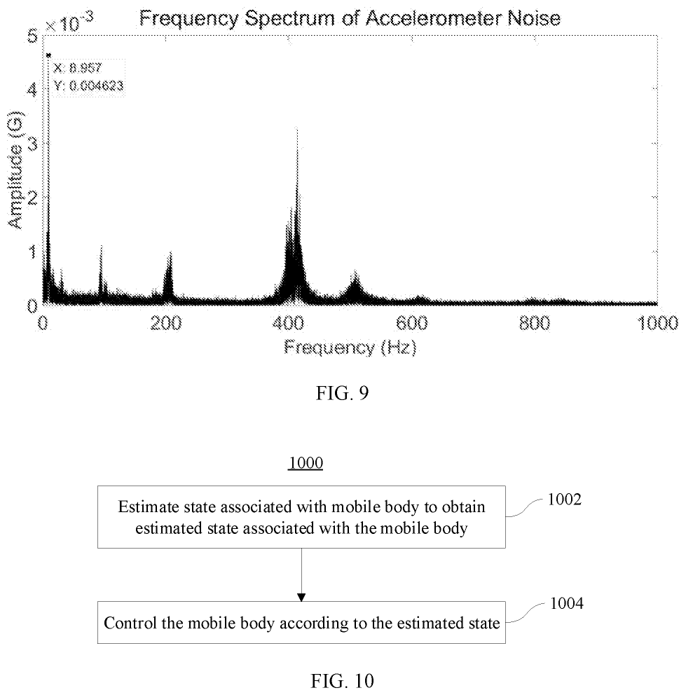

FIG. 9 shows an example frequency spectrum of accelerometer noise. As shown in FIG. 9, a low-frequency non-Gaussian white noise caused by body vibrations exists at around 8.957 Hz.

FIG. 10 is a flow chart schematically showing a method 1000 for controlling a mobile body, such as an attitude of the mobile body, according to some embodiments of the disclosure. The mobile body can be, for example, a UAV, a gimbal carried by a UAV, or a hand-held gimbal. As show in FIG. 10, at 1002, a state associated with the mobile body is estimated. The state can be estimated according to a method consistent with the disclosure, such as any one of the examples of method described above. In some embodiments, a current attitude of the mobile body is estimated to obtain an estimated attitude of the mobile body. At 1004, the mobile body is controlled according to the estimated state associated with the mobile body, such as the estimated attitude of the mobile body. In some embodiments, the controlling of the mobile body can be dependent upon a difference between the estimated state and a desired state, such as a difference between the estimated attitude and a desired attitude of the mobile body. For example, if the estimated attitude is the same as the desired attitude, the mobile body can be controlled to maintain the current attitude. On the other hand, if the estimated attitude is different from the desired attitude, the mobile body can be controlled to rotate to the desired attitude.

The processes shown in the figures associated with the method embodiments can be executed or performed in any suitable order or sequence, which is not limited to the order and sequence shown in the figures and described above. For example, two consecutive processes may be executed substantially simultaneously where appropriate or in parallel to reduce latency and processing times, or be executed in an order reversed to that shown in the figures, depending on the functionality involved.

Further, the components in the figures associated with the device embodiments can be coupled in a manner different from that shown in the figures as needed. Some components may be omitted and additional components may be added.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A method for estimating a state associated with a mobile body, comprising:
obtaining measurements from a plurality of measuring devices associated with the mobile body, the plurality of measuring devices including an accelerometer and the measurement from the accelerometer being filtered using a noise filter;
predicting, based at least in part on a first estimate of the state associated with the mobile body and a plurality of models, a second estimate of the state, the plurality of models including a filter model for the noise filter; and
updating the second estimate of the state based at least in part on the measurements from the plurality of measuring devices to obtain a third estimate of the state.

2. The method of claim 1, wherein predicting the second estimate of the state is further based at least in part on the measurements from the plurality of measuring devices.

3. The method of claim 2, wherein the plurality of measuring devices include a gyroscope.

4. The method of claim 1, wherein the plurality of measuring devices further include at least one of a gyroscope or a magnetometer.

5. The method of claim 4, wherein the magnetometer is attached to the mobile body or a carrier carrying the mobile body.

6. The method of claim 4, wherein the plurality of measuring devices further include a translational acceleration measurement device.

7. The method of claim 1, wherein the plurality of model further include an attitude kinematic model and one or more measuring device models, each of the one or more measuring device models modeling one of the measuring devices.

8. The method of claim 1, wherein the state associated with the mobile body includes an attitude of the mobile body, a bias associated with at least one of the measuring devices, and an output of the noise filter.

9. The method of claim 1, wherein the noise filter is configured to reduce a measurement noise associated with the accelerometer.

10. The method of claim 9, wherein the noise filter includes a band-stop filter configured to attenuate a range of frequencies corresponding to the measurement noise.

11. The method of claim 10, further comprising:
estimating the range of frequencies corresponding to the measurement noise.

12. The method of claim 11, wherein estimating the range of frequencies corresponding to the measurement noise includes estimating based at least in part on an estimated attitude of the mobile body and an unfiltered acceleration.

13. The method of claim 1, wherein predicting the second estimate of the state includes:
predicting, based at least in part on a first estimate of an error state associated with the mobile body, a second estimate of the error state associated with the mobile body; and
predicting, based at least in part on a first estimate of a primal state associated with the mobile body, a second estimate of the primal state associated with the mobile body.

14. The method of claim 13, wherein predicting the second estimate of the error state is further based at least in part on angular measurements from at least one of the plurality of measuring devices.

15. The method of claim 14, wherein the at least one of the plurality of measuring devices includes a gyroscope.

16. The method of claim 13, wherein predicting the second estimate of the primal state is further based at least in part on angular measurements from at least one of the plurality of measuring devices.

17. The method of claim 1, wherein updating the second estimate of the state includes:
updating the second estimate of the error state to obtain a third estimate of the error state associated with the mobile body; and
updating the second estimate of the primal state to obtain a third estimate of the primal state associated with the mobile body.

18. The method of claim 17, wherein updating the second estimate of the error state is based at least in part on the measurements from the plurality of measuring devices.

19. The method of claim 17, wherein updating the second estimate of the primal state is based at least in part on the third estimate of the error state.

20. A device for estimating a state associated with a mobile body, comprising:
a processor; and
a memory storing instructions that, when executed by the processor, cause the processor to:
obtain measurements from a plurality of measuring devices associated with the mobile body, the plurality of measuring devices including an accelerometer and the measurement from the accelerometer being filtered using a noise filter;
predict, based at least in part on a first estimate of the state associated with the mobile body and a plurality of models, a second estimate of the state, the plurality of models including a filter model for the noise filter; and
update the second estimate of the state based at least in part on the measurements from the plurality of measuring devices to obtain a third estimate of the state.
